(19) United States
(12) Patent Application Publication
(10) Pub. No.: US 2016/0132513 A1
(43) Pub. Date: May 12, 2016

(54) DEVICE AND METHOD FOR PROVIDING POI INFORMATION USING POI GROUPING

(71) Applicant: SK PLANET CO., LTD., Gyeonggi-do (KR)

(72) Inventors: So-Young Lim, Gyeonggi-do (KR); Heon-Kyu Park, Gyeonggi-do (KR); Sung-Joon Park, Gyeonggi-do (KR); Hong-Jun An, Seoul (KR)

(73) Assignee: SK PLANET CO., LTD., Gyeonggi-do (KR)

(21) Appl. No.: 14/899,081

(22) PCT Filed: Dec. 10, 2014
(86) PCT No.: PCT/KR2014/012161

§ 371 Date: Dec. 16, 2015

(30) Foreign Application Priority Data
Feb. 5, 2014 (KR) 10-2014-0012974
Feb. 14, 2014 (KR) 10-2014-0017212
Mar. 27, 2014 (KR) 10-2014-0036324
Apr. 17, 2014 (KR) 10-2014-0046163
Apr. 23, 2014 (KR) 10-2014-0048915

(51) Int. Cl. G06F 17/30

(52) U.S. Cl. CPC G06F 17/3087; G06F 17/30598; G06F 17/3053; G06F 17/30867; G06F 17/30241

(57) ABSTRACT

The present invention is directed to a device and method for providing POI information using POI grouping. According to the present invention, POI objects are collected in a preset POI category, a POI group is generated by grouping some of the POI objects using additional information included in each of the POI objects, related POI objects corresponding to a target POI object corresponding to a request from a user are extracted using the POI group, and information corresponding to the related POI objects is transmitted to the user. Related POI objects are extracted and then information is transmitted in response to a request from a user, and thus information about a location desired by the user is provided in a related group, thereby efficiently providing appropriate information.

### CROSS REFERENCE TO RELATED APPLICATIONS

The present invention claims the benefits of the filing dates of Korean Patent Application No. 10-2014-0012974 filed on Feb. 5, 2014, Korean Patent Application No. 10-2014-0017212 filed on Feb. 14, 2014, Korean Patent Application No. 10-2014-0036324 filed on Mar. 27, 2014, Korean Patent Application No. 10-2014-0046163 filed on Apr. 17, 2014, and Korean Patent Application No. 10-2014-0048915 filed on Apr. 23, 2014, the content of which is incorporated herein in their entirety.

### Technical Field

The present invention relates generally to a device and method for providing Point Of Interest (POI) information using POI grouping, which provide POI information, requested by a user, using POI grouping, and more particularly to a device and method for providing POI information using POI grouping, which can generate a POI object group using additional information included in POI objects and provide information about POI objects, related to a request from a user, to the user using the generated POI object group.

### BACKGROUND ART

In currently constructed information about a massive number of Point Of Interests (POIs), additional information, for example, the menu information of information in a category classified as a restaurant class, has been collected and managed by data provision service companies and web crawling. However, technology related to the extension of data application, which performs grouping by analyzing the similarity of data using additional information or recommends alternative data using a data group generated by grouping, has been rarely popularized.

When information is searched for, there are many cases where users have specific needs for information that is a target for a search. If information can be searched for via data groups based on such specific needs, the effect of more easily retrieving larger amounts of related information can be achieved.

Accordingly, there is an urgent need for technology for providing POI information using POI grouping, which generates a POI group by grouping some of POI objects using the additional information of POI objects and extracts related POI objects corresponding to a request from a user using the POI group, thereby providing related information to the user.

Furthermore, the amount of constructed data on POIs is massive, and also the data can be continuously added and changed. Accordingly, there is a need for the development of technology that can effectively set AOIs using such POIs as statistical data.

Furthermore, a distance measurement function that is provided by a conventional electronic map has inconvenience in which, once a user has initially set a point for the measurement of a distance on a map, the point cannot be modified and thus the distance measurement function must be performed again from the beginning. Accordingly, there is an urgent need for new technology for the measurement of a distance on an electronic map, which can overcome the above problem.

Furthermore, there is an urgent need for new space search technology that can automatically recognize and construct a hierarchical structure, rather than manually designating the upper and lower levels of a hierarchical structure, thereby conveniently providing the area of a POI and an upper and lower hierarchical structure while reducing task time and avoiding the omission of a POI.

### DISCLOSURE

### Technical Problem

An object of the present invention is to provide various types of application information regarding related POI objects appropriate for a purpose requested by a user, thereby enabling the user to select an optimum location.

Furthermore, an object of the present invention is to compare the prices or pieces of preference information of eh content of POI objects using the additional information of the POI objects, thereby providing application information that can be used for marketing.

Furthermore, the present invention is intended to overcome the inconvenience of the distance measurement function of a conventional electronic map in which, once a user has initially set a point for the measurement of a distance on a map, the point cannot be modified and thus the distance measurement function must be performed again from the beginning. An object of the present invention is to provide a method for measuring a distance on an electronic map and a system and device therefor, which display an electronic map by executing an application, which, when a plurality of points for a distance measurement function is sequentially selected, generate measured information by applying location information to each of the points and display measured information on the map, which, when the location information of a specific point is changed, modify the measured information by incorporating the changed location information into the measured information and display the modified measured information on the map.

Furthermore, an object of the present invention is to separately store and connect a POI object and an area object, thereby adding an area to a POI.

Furthermore, an object of the present invention is to automatically extract a child POI object through a space search for a POI object without manually designating the child POI object.

Furthermore, an object of the present invention is to extract a grandchild POI object through a space search for a child POI object, thereby constructing a 2 or higher-level hierarchical structure.

Furthermore, an object of the present invention is to automatically construct a hierarchical structure, thereby reducing task time.

Furthermore, an object of the present invention is to dynamically maintain a hierarchical structure, thereby rarely incurring maintenance costs and also enabling immediate application when a POI or an area is changed.

Furthermore, an object of the present invention is to provide a navigation device and method and a storage medium storing a computer program, which can make a search for a path by applying road information (or road attribute information) along the path upon a search for a path.

### Technical Solution

In order to accomplish the above objects, the present invention provides a device for providing Point Of Interest (POI) information, including: a POI storage unit configured to collect POI objects in a preset POI category; a POI grouping unit configured to generate a POI group by grouping some of the POI objects using additional information included in each of the POI objects; and a POI communication unit configured to extract related POI objects corresponding to a target POI object corresponding to a request from a user using the POI group, and to transmit information corresponding to the related POI objects to the user.

In this case, the POI communication unit may recommend at least one or more POI objects close to the current location of the user among the related POI objects using the basic information of the related POI objects.

In this case, the POI communication unit may generate at least one or more of price comparison information and preference ranking information for the related POI objects, and may provide the generated information to the user.

In this case, the POI communication unit may generate a related POI list using at least one or more of the basic information of the related POI objects and the additional information; and may generate at least one or more of the price comparison information and the preference ranking information using the related POI list.

In this case, the basic information may be information about the POI objects, and the additional information may be information about the content of the POI objects based on the type of preset POI category.

In this case, the POI grouping unit may compare the pieces of additional information included in the POI objects, and may extract and group one or more POI objects having identical or similar additional information among the POI objects.

In this case, the POI grouping unit may search for a synonym for the additional information using a thesaurus, and may determine POI objects having the synonym as the additional information to be the POI objects having similar additional information.

Furthermore, the present invention provides a method of providing POI information, including: collecting POI objects in a preset POI category; generating a POI group by grouping some of the POI objects using additional information included in each of the POI objects; and extracting related POI objects corresponding to a target POI object corresponding to a request from a user using the POI group, and transmitting information corresponding to the related POI objects to the user.

In this case, transmitting the information to the user may include recommending at least one or more POI objects close to the current location of the user among the related POI objects using the basic information of the related POI objects.

In this case, transmitting the information to the user may include generating at least one or more of price comparison information and preference ranking information for the related POI objects, and providing the generated information to the user.

In this case, transmitting the information to the user may include generating a related POI list using at least one or more of the basic information of the related POI objects and the additional information, and generating at least one or more of the price comparison information and the preference ranking information using the related POI list.

In this case, the basic information may be information about the POI objects, and the additional information may be information about the content of the POI objects based on the type of preset POI category.

In this case, generating the POI group may include comparing the pieces of additional information included in the POI objects, and extracting and grouping one or more POI objects having identical or similar additional information among the POI objects.

In this case, generating the POI group may include searching for a synonym for the additional information using a thesaurus, and determining POI objects having the synonym as the additional information to be the POI objects having similar additional information.

In order to accomplish the above objects, an embodiment of the present invention provides a device for extracting an area of interest (AOI) using a POI distribution chart, including: a keyword input unit configured to transfer a keyword input in accordance with a specific area; a POI distribution chart calculation unit configured to determine location coordinates set for the keyword transferred via the keyword input unit, and to calculate a Point-Of-Interest (POI) distribution chart with the determined location coordinates as its center; and an area setting unit configured to set an area where the number of POIs is equal to or larger than a predetermined value as an AOI based on the POI distribution chart calculated by the POI distribution chart calculation unit.

In this case, the device for extracting an AOI may further include an interface unit configured to transmit and receive information to and from one or more terminals, and the keyword input unit may receive a keyword, input in accordance with a specific area, from any one of the terminals via the interface unit, and determine the keyword.

Furthermore, the POI distribution chart calculation unit may determine at least one synonym including the name of an administrative address related to the keyword, may determine location coordinates set for the keyword and location coordinates set for the synonym, and may calculate a POI distribution chart with the determined location coordinates as its center.

In this case, the POI distribution chart calculation unit may calculate the POI distribution chart by sequentially moving a scan area from first determined location coordinates to second determined location coordinates, may set a first scan area having a predetermined size at the first location coordinates, may determine the number of POIs within the first scan area, and may set a second scan area larger than the first scan area when the number of POIs within the first scan area is equal to or larger than a predetermined value.

The area setting unit may determine a POI included in the second scan area, may connect the outer coordinate values of the POI, and may set the connected area as an AOI.

The first scan area may be differently set based on the size of the specific area.

The area setting unit may store information, including at least any one of a name, a category and additional information mapped to at least one POI included in the AOI, with the information being mapped to the AOI.

The area setting unit may further include a service provision unit configured to provide the AOI and information mapped to the AOI in response to a request from a specific terminal.

In order to accomplish the above objects, an embodiment of the present invention provides a device for extracting an area of interest (AOI) using a POI distribution chart, including: a keyword input unit configured to transfer a keyword input in accordance with a specific area; a POI distribution chart calculation unit configured to determine location coordinates set for the keyword transferred via the keyword input unit, and to calculate a Point-Of-Interest (POI) distribution chart with the determined location coordinates as its center; and an area setting unit configured to set an area where the number of POIs is equal to or larger than a predetermined value as an AOI based on the POI distribution chart calculated by the POI distribution chart calculation unit.

In this case, the device for extracting an AOI may further include an interface unit configured to transmit and receive information to and from one or more terminals, and the keyword input unit may receive a keyword, input in accordance with a specific area, from any one of the terminals via the interface unit, and determine the keyword.

Furthermore, the POI distribution chart calculation unit may determine at least one synonym including the name of an administrative address related to the keyword, may determine location coordinates set for the keyword and location coordinates set for the synonym, and may calculate a POI distribution chart with the determined location coordinates as its center.

In this case, the POI distribution chart calculation unit may calculate the POI distribution chart by sequentially moving a scan area from first determined location coordinates to second determined location coordinates, may set a first scan area having a predetermined size at the first location coordinates, may determine the number of POIs within the first scan area, and may set a second scan area larger than the first scan area when the number of POIs within the first scan area is equal to or larger than a predetermined value.

The area setting unit may determine a POI included in the second scan area, may connect the outer coordinate values of the POI, and may set the connected area as an AOI.

The first scan area may be differently set based on the size of the specific area.

The area setting unit may store information, including at least any one of a name, a category and additional information mapped to at least one POI included in the AOI, with the information being mapped to the AOI.

The area setting unit may further include a service provision unit configured to provide the AOI and information mapped to the AOI in response to a request from a specific terminal.

In order to accomplish the above objects, an embodiment of the present invention provides a system for extracting an AOI using a POI distribution chart, including: a terminal configured to transmit a keyword input in accordance with a specific area; and an AOI extraction device configured to, when the keyword input in accordance with the specific area is received from the terminal, determine location coordinates set for the keyword, calculate a POI distribution chart with the determined location coordinates as its center, set an area where the number of POIs is equal to or larger than a predetermined value as an AOI based on the calculated POI distribution chart, and provide the AOI to the terminal.

In order to accomplish the above objects, an embodiment of the present invention provides a method of extracting an AOI using a POI distribution chart, including: by an AOI extraction device; determining a keyword input in accordance with a specific area; determining location coordinates set for the keyword, and calculating a POI distribution chart with the determined location coordinates as its center; and setting an area where a number of POIs is equal to or larger than a predetermined value as an AOI based on the calculated POI distribution chart.

In this case, the method of extracting an AOI using a POI distribution chart, may further include, before calculating the POI distribution chart, determining one or more synonyms including the name of a related administrative address of a keyword input in accordance with a specific area; and calculating the POI distribution chart may include determining location coordinates set for the keyword and location coordinates set for the one or more synonyms and calculating the POI distribution chart with the determined location coordinates as its center.

Furthermore, calculating the POI distribution chart may include calculating the POI distribution chart by sequentially moving a scan area from first determined location coordinates to second determined location coordinates, setting a first scan area having a predetermined size at the first location coordinates, determining the number of POIs within the first scan area, and setting a second scan area larger than the first scan area when the number of POIs within the first scan area is equal to or larger than a predetermined value.

Furthermore, setting the AOI may include determining a POI included in the second scan area, connecting the outer coordinate values of the POI, and setting the connected area as the AOI.

Furthermore, the method of extracting an AOI using a POI distribution chart, may further include, after setting the AOI, storing information, including at least any one of a name, a category and additional information mapped to at least one POI included in the AOI, with the information being mapped to the AOI.

In order to accomplish the above objects, an embodiment of the present invention provides a method of extracting an AOI using a POI distribution chart, including: calculating, by an AOI extraction device, a POI distribution chart for a specific area at predetermined periods; setting an area where the number of POIs is equal to or larger than a predetermined value as an AOI based on the calculated POI distribution chart; and setting the AOI as a recommended area when the set AOI is a recently set AOI.

Additionally, the present invention may provide a computer-readable storage medium having stored thereon a program for executing the method of extracting an AOI using a POI distribution chart.

In order to accomplish the above objects, an embodiment of the present invention provides a service device, including: a service communication unit configured to transmit and receive information for the measurement of a distance on an electronic map while communicating with at least one terminal; and a service control unit configured to perform control in order to, when the information for measurement of a distance on an electronic map provided via a map application is received from the terminal, determine the location information of a plurality of points based on the received information, calculate measured information by applying the location information and then transmit the measured information to the terminal, and in order to, when an input signal adapted to change a location of one of a plurality of points indicated on the electronic map is received, modify the measured information by incorporating changed location information into the measured information and then provide the modified measured information to the terminal.

Furthermore, in the service device according to the present invention, the measured information may include distance information adapted to connect individual selected points on the electronic map and information about the time required to move from a start point to a destination point using at least one transportation means of walking, a bicycle, a private car and a public transportation means.

Furthermore, in the service device according to the present invention, the service control unit may receive the location information of a moved point in response to a drag & drop touch signal input, at a location at which a specific point is indicated, from the terminal.

Furthermore, the service device according to the present invention may further include a service storage unit configured to store an electronic map provided via the map application and information about a public transportation means available between start and destination points of the plurality of points.

In order to accomplish the above objects, an embodiment of the present invention provides a terminal, including: a communication unit configured to transmit and receive information for measurement of a distance on an electronic map while communicating with a service device; and a control unit configured to perform control in order to display an electronic map via the map application when the map application is executed, to determine location information of a plurality of points and transmit the location information to a service device when input signals adapted to sequentially select the plurality of points are detected via the distance measurement function, to display the measured information and a distance between the points on the electronic map when measured information is received from the service device, to transmit an input signal to the service device when the input signal adapted to change a location of one of the plurality of points is detected, and to modify and display the measured information and the distance between the points on the electronic map when the measured information to which the changed location information has been applied is received from the service device.

Furthermore, in the terminal according to the terminal, the control unit may perform control in order to display the electronic map via the application when the map application is executed, to determine location information of a plurality of points and calculate measured information by applying the location information when input signals adapted to sequentially select the plurality of points are detected via the distance measurement function, and to determine the changed location information using the terminal, modify the measured information by incorporating the changed location information into the measured information and then provide the modified measured information when location information of at least one of the plurality of points is changed.

In order to accomplish the above objects, an embodiment of the present invention provides a system for measuring a distance on an electronic map, including: a terminal configured to display an electronic map via the map application when the map application is executed, to determine location information of a plurality of points and transmit the location information to a service device when input signals adapted to sequentially select the plurality of points are detected via the distance measurement function, to display the measured information and a distance between the points on the electronic map when measured information is received from the service device, to transmit an input signal to the service device when the input signal adapted to change a location of one of the plurality of points is detected, and to modify and display the measured information and the distance between the points on the electronic map when the measured information to which the changed location information has been applied is received from the service device; and a service device configured to determine location information of a plurality of points based on received information, calculate measured information by applying the location information and then transmit the measured information to the terminal when the information for measurement of a distance on an electronic map provided via a map application is received from the terminal, and to modify the measured information by incorporating changed location information into the measured information and then provide the modified measured information to the terminal when an input signal adapted to change a location of one of a plurality of points indicated on the electronic map is received.

In order to accomplish the above objects, an embodiment of the present invention provides a method of measuring a distance on an electronic map, including: when a map application is executed, displaying, by a terminal, an electronic map on a map application, and selecting, by the terminal, a distance measurement function on the electronic map; detecting, by the terminal, input signals adapted to sequentially select a plurality of points, and determining, by the terminal, location information of the plurality of points; calculating, by the terminal, measured information by applying location information of the plurality of points; and, when location information of at least one of the plurality of points is changed, determining, by the terminal, the changed location information, modifying, by the terminal, the measured information by incorporating the changed location information into the measured information, and then providing the modified measured information.

In the method of measuring a distance on an electronic map according to the present invention, calculating the measured information may include determining the measured information including distance information adapted to connect the individual selected points on the electronic map and information about the time required to move from a start point to a destination point using at least one transportation means of walking, a bicycle, a private car and a public transportation means.

In the method of measuring a distance on an electronic map according to the present invention, providing the modified measured information may include detecting a drag & drop touch signal input at a location at which one of a plurality of selected points is indicated on the electronic map; determining the location information of a moved point in response to the detected touch signal; and recalculating the measured information by incorporating the determined location information into the measured information.

The method of measuring a distance on an electronic map according to the present invention may further include, after calculating the measured information, displaying the measured information calculated by the terminal and the distance between the points on the electronic map.

In the method of measuring a distance on an electronic map according to the present invention, providing the modified measured information may include modifying and displaying, by the terminal, the measured information into which the modified location information has been incorporated and the distance between the points on the electronic map.

An embodiment of the present invention provides a method of measuring a distance on an electronic map, including: when a map application is executed, displaying, by a terminal, an electronic map via the map application, and selecting, by the terminal, a distance measurement function on an electronic map; detecting, by the terminal, input signals adapted to sequentially select a plurality of points, determining, by the terminal, the location information of the plurality of points, and transmitting, by the terminal, the determined location information to a service device; receiving, by the terminal, measured information from the service device, and displaying, by the terminal, the received measured information and the distance between the points on an electronic map; when the input signal adapted to change a location of one of the plurality of points is detected, transmitting, by the terminal, the input signal to the service device; and receiving, by the terminal, the measured information to which the changed location information has been applied from the service device, and modifying and displaying, by the terminal, the measured information and the distance between the points on the electronic map.

In the method of measuring a distance on an electronic map according to the present invention, modifying and displaying the measured information and the distance may include detecting, by the terminal, a drag & drop touch signal input at a location at which one of a plurality of selected points is indicated on the electronic map; determining, by the terminal, the location information of a moved point in response to the detected touch signal; and transmitting, by the terminal, the determined location information to the service device.

An embodiment of the present invention provides a method of measuring a distance on an electronic map, including: receiving, by a service device, an input signal for the measurement of a distance on an electronic map provided via a map application from at least one terminal; determining, by the service device, the location information of a plurality of points based on the input signal; calculating, by the service device, measured information by applying the determined location information; transmitting, by the service device, the calculated measured information to a terminal; receiving, by the service device, an input signal adapted to change the location of one of a plurality of points indicated on the electronic map; and in response to the input signal, modifying, by the service device, the measured information by incorporating the changed location information into the measured information with respect to the one point, and providing, by the service device, the modified measured information to the terminal.

As another means for achieving the objects of the present invention, there is provided a computer-readable storage medium having stored thereon a program for executing: when a map application is executed, displaying an electronic map via the map application, and selecting a distance measurement function on an electronic map; detecting input signals adapted to sequentially select a plurality of points, and determining the location information of the plurality of points; calculating measured information by applying the location information of the plurality of points; and, when the location information of at least one of the plurality of points is changed, determining the changed location information, modifying the measured information by incorporating the changed location information into the measured information, and providing the modified measured information.

As another means for achieving the objects of the present invention, there is provided a computer-readable storage medium having stored thereon a program for executing: when a map application is executed, displaying an electronic map via the map application, and selecting a distance measurement function on an electronic map; detecting input signals adapted to sequentially select a plurality of points, determining the location information of the plurality of points, and transmitting the determined location information to a service device; receiving measured information from the service device, and displaying the received measured information and the distance between the points on an electronic map; when the input signal adapted to change a location of one of the plurality of points is detected, transmitting the input signal to the service device; and receiving the measured information to which the changed location information has been applied from the service device, and modifying and displaying the measured information and the distance between the points on the electronic map.

As another means for achieving the objects of the present invention, there is provided a computer-readable storage medium having stored thereon a program for executing: receiving information for the measurement of a distance on an electronic map provided via a map application from at least one terminal; determining the location information of a plurality of points based on the received information; calculating measured information by applying the determined location information; transmitting the calculated measured information to a terminal; receiving an input signal adapted to change the location of one of a plurality of points indicated on the electronic map; and in response to the input signal, modifying the measured information by incorporating the changed location information into the measured information with respect to the one point, and providing the modified measured information to the terminal.

In order to accomplish the above objects, the present invention provides a space search service device, including: an area storage unit configured to store area objects corresponding to areas within a map; a POI storage unit configured to store a plurality of POI objects, at least some of which match the area objects; and a search unit configured to, when there is an area object matching a POI object corresponding to an input of a user, make a space search for the POI object and provide an extracted child POI object.

In this case, the space search may extract a POI object, present within an area corresponding to an area object matching the POI object that is a target for the space search, as a child POI object.

In this case, the search unit may make a space search for the child POI object and then provide an extracted grandchild POI object when there is an area object matching the child POI object.

In this case, the search unit may provide a child POI object obtained by excluding a POI object corresponding to a grandchild POI object from the extracted child POI object.

In this case, the space search may extract a POI object matching an overlapping area object as a child POI object when there is the area object whose area overlaps an area object, matching the POI object that is a target for the space search, at a predetermined or higher rate.

In this case, the POI object corresponding to the input of the user may correspond to a building, and the child POI object may correspond to a floor of the building.

In this case, areas within the map corresponding to the area objects may be polygonal areas.

Furthermore, the present invention provides a space search service method, including: storing area objects corresponding to areas within a map; storing a plurality of POI objects, at least some of which match the area objects; and determining whether there is an area object matching a POI object corresponding to an input of a user; when there is a matching area object, extracting a child POI object by making a space search for the POI object; and providing the extracted child POI object.

In this case, the space search service method may further include determining whether there is an area object matching the child POI object; when there is an area object matching the child POI object, extracting a grandchild POI object by making a space search for the child POI object; and providing the extracted grandchild POI object.

In this case, providing the extracted child POI object may include providing a child POI object obtained by excluding a POI object corresponding to a grandchild POI object from the extracted child POI object.

Furthermore, an embodiment of the present invention provides a navigation device, including; a display unit configured to receive destination information based on a touch of a user; and a control unit configured to make a search for a path based on the destination information, to search for a POI by applying preset road information with respect to a path included in a result of the performed search for a path, and control the display unit in order to display the result of the search for a path and POI information corresponding to the retrieved road information.

As an example related to the present invention, the control unit may search for the shortest distance or time path among a plurality of paths to a destination included in the destination information.

As an example related to the present invention, the road information may include at least one of a road type, a road scale, a road function, lane information, facility information, and road speed information.

As an example related to the present invention, the control unit may search for a POI located around the path by applying the preset road information to the path included in the result of the performed search for a path.

As an example related to the present invention, the control unit may search for one or more service areas located on an expressway of the path among a plurality of POIs located on the path based on expressway information included in the road type of the road information when the expressway is included in the path included the result of the search for a path.

As an example related to the present invention, the control unit may control the display unit so that information about the POI flickers when a current location of a navigation device including in the display unit is located within a preset distance from the POI information.

As an example related to the present invention, the control unit may perform control such that detailed information of the POI information is displayed on the display unit when the POI information is selected.

As an example related to the present invention, when the POI information is selected as a stop, the control unit may make a search again for a path passing through the selected POI information among the paths to the destination included in the destination information, and may control the display unit so that the result of the performed search for a path is displayed.

An embodiment of the present invention provides a navigation method, including: receiving destination information based on a touch of a user via a display unit; making a search for a path based on the received destination information via a control unit; searching for a POI by applying preset road information with respect to a path included in the result of the performed search for a path via the control unit; and displaying the result of the search for a path and POI information corresponding to the retrieved road information control via the display unit.

As an example related to the present invention, the destination information may be acquired via any one of: the process of receiving destination information based on the touch of a user via a user input screen displayed on a display unit; the process of receiving destination information based on the input of a user via an input unit; and the process of receiving a signal including destination information transmitted from another terminal via a communication unit.

As an example related to the present invention, making the search for the path may include searching for the shortest distance or time path among a plurality of paths to a destination included in the destination information.

As an example related to the present invention, the navigation method may further include, when POI information corresponding to the retrieved road information is selected, displaying, by the display unit, the detailed information of the POI information; when the POI information is selected as a stop, making, by the control unit, again, a search for a path passing through the selected POI information among the paths to the destination included in the destination information; and displaying, by the display unit, the result of the performed search for a path.

An embodiment of the present invention provides a storage medium having stored thereon a computer program for executing the method set forth in one of the above-described embodiments.

### Advantageous Effects

According to the present invention, related POI objects corresponding to a request from a user can be easily acquired via a POI group, thereby efficiently providing an optimum location desired by the user.

Furthermore, according to the present invention, application information required for marketing can be extracted and used using grouped POI information.

Furthermore, according to the present invention, an AOI is extracted and managed using previously constructed POI data, thereby enabling the extraction of an accurate AOI without incurring separate costs for the extraction of an AOI.

Furthermore, according to the present invention, an area that has not been an AOI can be recommended as an AOI based on a POI distribution chart, a rising area or falling area can be expected based on changes in the POI distribution chart, and information about a business district based on a POI distribution chart can be extracted and provided to another system or the like.

Furthermore, according to the present invention, a user can freely modify a specific one of a plurality of points, displayed on the electronic map for the measurement of a distance, on the screen, so that a scale displayed on a screen can be repeatedly modified even when the user erroneously selects another point when the user measures a distance, and a screen can be intuitively changed, so that the measurement of a distance can be efficiently used.

Furthermore, as the location of a specific point is changed on the electronic map, information about a distance and a transportation means is automatically changed and displayed on the image of the electronic map, thereby enabling a user to conveniently use the information.

Furthermore, according to the present invention, an area can be added to a POI by separately storing and connecting a POI object and an area object.

Furthermore, according to the present invention, a child POI object can be automatically extracted through a space search for a POI object without manually designating the child POI object.

Furthermore, according to the present invention, a 2 or higher-level hierarchical structure can be constructed by extracting a grandchild POI object through a space search for a child POI object.

Furthermore, according to the present invention, task time can be reduced by automatically constructing a hierarchical structure.

Furthermore, according to the present invention, a hierarchical structure can be dynamically maintained, and thus maintenance costs are rarely incurred and also immediate application is enabled when a POI or an area is changed.

Furthermore, the present invention is advantageous in that a search for a path is made by applying road information (or road attribute information) along the path upon a search for a path, thereby providing a POI search result useful to a user and also improving the convenience of use.

### DESCRIPTION OF DRAWINGS

FIG. 1 is a diagram showing a system for providing POI information according to an embodiment of the present invention;

FIG. 2 is a block diagram showing a device for providing POI information according to an embodiment of the present invention;

FIG. 3 is a diagram showing an example of a POI information provision screen according to the present invention;

FIG. 4 is a diagram showing an example of related POI information for price comparison according to the present invention;

FIG. 5 is a diagram showing an example of related POI information for distance comparison according to the present invention;

FIG. 6 is an operation flowchart showing a method of providing POI information according to an embodiment of the present invention;

FIG. 7 is an operation flowchart showing a POI grouping method according to an embodiment of the present invention;

FIG. 8 is a diagram schematically showing the configurations of the principal components of a system for extracting an AOI using a POI distribution chart according to an embodiment of the present invention;

FIG. 9 is a block diagram showing the principal configurations of the terminal according to the embodiment of the present invention, which is shown in FIG. 8;

FIG. 10 is a block diagram showing the principal configurations of the AOI extraction device according to the embodiment of the present invention, which is shown in FIG. 8;

FIG. 11 is a flowchart illustrating a method of extracting an AOI using a POI distribution chart according to an embodiment of the present invention;

FIG. 12 is a flowchart illustrating a method of extracting an AOI using a POI distribution chart according to an embodiment of the present invention in greater detail;

FIG. 13 is a flowchart illustrating a method of calculating a POI distribution chart according to an embodiment of the present invention in greater detail;

FIG. 14 is an exemplary screen shot illustrating a method of extracting an AOI using a POI distribution chart according to an embodiment of the present invention;

FIG. 15 is a diagram showing the configuration of a system for measuring a distance on an electronic map according to an embodiment of the present invention;

FIG. 16 is a block diagram showing the configuration of the terminal according to the present invention;

FIG. 17 is a block diagram showing the configuration of a service device according to the present invention;

FIG. 18 is a flowchart illustrating a method of measuring a distance on an electronic map according to an embodiment of the present invention;

FIG. 19 is a flowchart illustrating a method of operating a terminal while operating in conjunction with a service device according to an embodiment of the present invention;

FIG. 20 is a flowchart illustrating a method of operating a service device while operating in conjunction with a terminal according to an embodiment of the present invention;

FIGS. 21A and 21B are exemplary diagrams illustrating the method of measuring a distance on an electronic map according to the embodiment of the present invention;

FIG. 22 is a block diagram showing a space search service system according to an embodiment of the present invention;

FIG. 23 is a block diagram showing an example of the space search service device shown in FIG. 22;

FIG. 24 is a diagram showing an example of a hierarchical structure of a POI object and an area object according to an embodiment of the present invention;

FIG. 25 is an operation flowchart showing an example of a space search service method according to an embodiment of the present invention;

FIG. 26 is a block diagram showing the configuration of a navigation device according to an embodiment of the present invention;

FIG. 27 is a flowchart showing a navigation method according to an embodiment of the present invention; and

FIGS. 28 and 29 are views showing the screens of a navigation device according to an embodiment of the present invention.

### MODE FOR INVENTION

Preferred embodiments of the present invention will be described in detail below with reference to the accompanying drawings. However, detailed descriptions of well-known functions and configurations that may make the gist of the present invention unnecessarily obscure will be omitted in the following description and the attached drawings. Furthermore, it should be noted that the same components are designated by the same reference symbols throughout the drawings as much as possible.

The terms and words used in the following specification and the claims should not be restrictively interpreted as having common and dictionary meanings, but should be interpreted as having meanings and concepts in conformity with the technical spirit of the present invention based on the principle that an inventor can appropriately define the concepts of terms in order to describe his or her invention in the best way. Accordingly, since the embodiments described in the present specification and the configurations shown in the drawings merely correspond to the preferred embodiments of the present invention and do not cover all the technical spirit of the present invention, it should be appreciated that there may be various equivalents and modifications that may replace the configurations at the time at which the present application is filed. Furthermore, the terms “first,” “second” and so on are used to describe various components, and are intended to distinguish one component from other components but are not intended to limit these components.

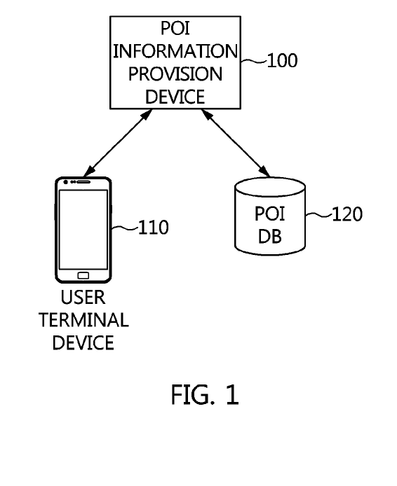

FIG. 1 is a diagram showing a system for providing POI information according to an embodiment of the present invention.

Referring to FIG. 1, the system for providing POI information according to the embodiment of the present invention may include a device 100 for providing POI information, a user terminal device 110, and a POI DB 120.

The device 100 for providing POI information may collect POI objects in a preset POI category. For example, the device 100 for providing POI information may collect POI objects related to restaurants in a restaurant category, and may collect POI objects related to general hospitals or private hospitals in a hospital category.

Furthermore, the device 100 for providing POI information may generate a POI group by grouping some of POI objects using additional information included in each of the POI objects. The grouping refers to arranging data having a common feature in a related group. A POI group may be generated by grouping POI objects having common additional information. In this case, the additional information may be information about the content of POI objects based on the type of preset POI category.

In this case, one or more of POI objects having the same additional information and POI objects having similar additional information may be extracted from POI objects by comparing pieces of additional information included in the respective POI objects, and then may be grouped. For example, when POI objects including “seolleongtang (an ox bone soup)” as additional information are grouped among POI objects in a restaurant category, one or more POI objects including “seolleongtang” in their additional information and one or more POI objects including the synonym “seolnongtang” in their additional information may be extracted and grouped together.

In this case, a synonym related to additional information may be searched for using a thesaurus, and POI objects including the synonym in their additional information may be determined to be POI objects having similar additional information.

Furthermore, the device 100 for providing POI information may extract related POI objects corresponding to a target POI object corresponding to a request from a user using a POI group, and may transmit information corresponding to the related POI objects to the user. For example, when a target POI object corresponding to a request from a user is a restaurant related POI object including “seolleongtang” as its additional information, a related POI may be extracted from POI objects included in a POI group grouped using additional information as “seolleongtang.” Furthermore, a related POI may be extracted from POI objects included in a POI group grouped using “seolnongtang,” i.e., a synonym for “seolleongtang,” as additional information.

In this case, at least one or more object close to the current location of the user among related POI objects may be recommended using the basic information of the related POI objects. For example, information about the distances between each of the related POI objects and the user may be calculated by acquiring the coordinate or address information of POIs included in the basic information of the extracted related POI objects and then acquiring the current location of the user from the user terminal device 110. Since most users chiefly search for destinations close to their current locations when searching for locations, it may be possible to calculate distance information and then recommend related POIs to the user in order of proximity.

In this case, at least one or more of price comparison information and preference ranking information may be generated for the related POI objects, and may be provided to the user. For example, related POI objects for the additional information “seolleongtang” may be extracted in response to a request from the user, and price information may be also provided when related POI information is provided based on additional information, thereby enabling the user to compare prices in restaurants which sell the same “seolleongtang.” Furthermore, related POIs may be provided in order of preference using information about ratings which users have assigned to respective POI objects, thereby enabling a user to receive information about restaurants having high preferences among restaurants which sell the same “seolleongtang.”

In this case, a related POI list may be generated using at least one or more of the basic information and additional information of the related POI objects, and at least one or more of the price comparison information and the preference ranking information may be generated using the related POI list. The related POI list is a list indicating information based on the basic information and additional information of the related POI objects based on the additional information. For example, address information or coordinate information included in the basic information may be indicated in a list prepared based on additional information for the food menu or price information, ingredient information or the like for a food menu, i.e., additional information, may be indicated in the list, thereby enabling users to make selection based on various types of information when selecting locations.

In this case, the basic information may be information about POI objects, and the additional information may be information about the content of the POI objects based on the type of preset POI category. For example, the basic information may be information about the coordinate information object category of POI objects and information about object attributes, and the additional information may be menu information in the case of a restaurant category, a medical field in the case of a hospital category and product-on-sale information in the case of a store category, based on the category of a POI object.

The user terminal device 110 may acquire related POI information by requesting a search for additional information from the device 100 for providing POI information in order to receive POI information, or by selecting a target POI object.

In this case, when receiving information corresponding to related POI objects corresponding to the target POI object, the user terminal device 110 may transmit the current location of the user to the device 100 for providing POI information in order to receive POI information in order of the proximity of related POIs based on distance information.

The POI DB 120 may store the information of previously generated POI objects. When the device 100 for providing POI information collects POI objects in a preset category, it may collect the POI objects via the POI DB 120.

In this case, the POI DB 120 may update the information of the POI objects at preset periods.

A location appropriate for a request from the user may be recommended via the above-described system for providing POI information. When related POI information corresponding to a target POI object corresponding to a request from the user is provided, POI information can be more conveniently and efficiently provided, and thus the time required for a POI search desired by the user can be reduced.

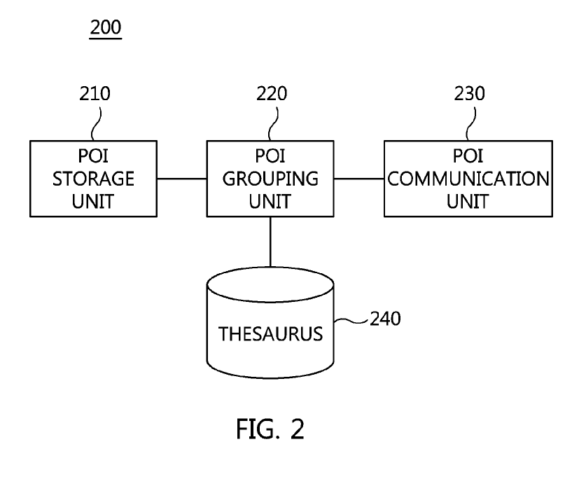

FIG. 2 is a block diagram showing a device for providing POI information according to an embodiment of the present invention.

Referring to FIG. 2, the device 200 for providing POI information according to the embodiment of the present invention may include a POI storage unit 210, a POI grouping unit 220, a POI communication unit 230, and a thesaurus 240.

The POI storage unit 210 may collect POI objects in a preset POI category. For example, the POI storage unit 210 may collect POI objects related to restaurants in a restaurant category, and may collect POI objects related to general hospital or a private hospital in a hospital category.

The POI grouping unit 220 may generate a POI group by grouping some of POI objects using additional information included in each of the POI objects. The grouping refers to arranging data having a common feature in a related group. A POI group may be generated by grouping POI objects having common additional information. In this case, the additional information may be information about the content of POI objects based on the type of preset POI category.

In this case, one or more of POI objects having the same additional information and POI objects having similar additional information may be extracted from POI objects by comparing pieces of additional information included in the respective POI objects, and then may be grouped. For example, when POI objects including “seolleongtang” as additional information are grouped among POI objects in a restaurant category, one or more POI objects including “seolleongtang” in their additional information and one or more POI objects including the synonym “seolnongtang” in their additional information may be extracted and grouped together.

In this case, a synonym related to additional information may be searched for using a thesaurus, and POI objects including the synonym in their additional information may be determined to be POI objects having similar additional information.

The POI communication unit 230 may extract related POI objects corresponding to a target POI object corresponding to a request from a user using a POI group, and may transmit information corresponding to the related POI objects to the user. For example, when a target POI object corresponding to a request from a user is a restaurant related POI object including “seolleongtang” as its additional information, a related POI may be extracted from POI objects included in a POI group grouped using additional information as “seolleongtang.” Furthermore, a related POI may be extracted from POI objects included in a POI group grouped using “seolnongtang,” i.e., a synonym for “seolleongtang,” as additional information.

In this case, at least one or more object close to the current location of the user among related POI objects may be recommended using the basic information of the related POI objects. For example, information about the distances between each of the related POI objects and the user may be calculated by acquiring the coordinate or address information of POIs included in the basic information of the extracted related POI objects and then acquiring the current location of the user from the user terminal device 110. Since most users chiefly search for destinations close to their current locations when searching for locations, it may be possible to calculate distance information and then recommend related POIs to the user in order of proximity.

In this case, at least one or more of price comparison information and preference ranking information may be generated for the related POI objects, and may be provided to the user. For example, related POI objects for the additional information “seolleongtang” may be extracted in response to a request from the user, and price information may be also provided when related POI information is provided based on additional information, thereby enabling the user to compare prices in restaurants which sell the same “seolleongtang.” Furthermore, related POIs may be provided in order of preference using information about ratings which users have assigned to respective POI objects, thereby enabling a user to receive information about restaurants having high preferences among restaurants which sell the same “seolleongtang.”

In this case, a related POI list may be generated using at least one or more of the basic information and additional information of the related POI objects, and at least one or more of the price comparison information and the preference ranking information may be generated using the related POI list. The related POI list is a list indicating information based on the basic information and additional information of the related POI objects based on the additional information. For example, address information or coordinate information included in the basic information may be indicated in a list prepared based on additional information for the food menu or price information, ingredient information or the like for a food menu, i.e., additional information, may be indicated in the list, thereby enabling users to make selection based on various types of information when selecting locations.

In this case, the basic information may be information about POI objects, and the additional information may be information about the content of the POI objects based on the type of preset POI category. For example, the basic information may be information about the coordinate information object category of POI objects and information about object attributes, and the additional information may be menu information in the case of a restaurant category, a medical field in the case of a hospital category and product-on-sale information in the case of a store category, based on the category of a POI object.

When a POI group is generated, the thesaurus 240 may provide the synonym information of additional information in order to determinate a POI object having similar additional information.

The above-described device 200 for providing POI information may provide related POI objects in a POI group related to additional information, thereby providing more reliable POI information to the user.

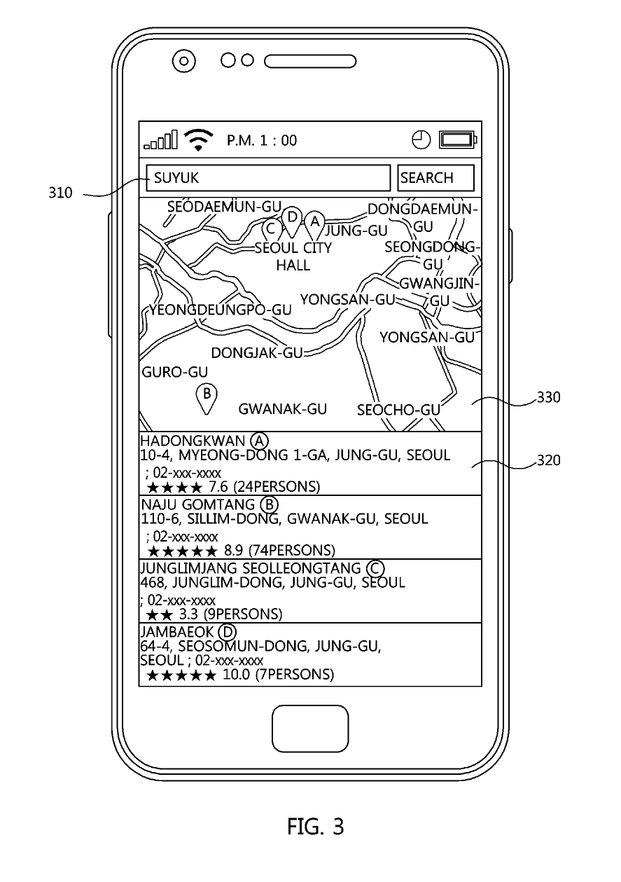

FIG. 3 is a diagram showing an example of a POI information provision screen according to the present invention.

Referring to FIG. 3, the POI information provision screen according to the present invention may include a user search box 310, a search result list 320, and a search map box 330.

The user search box 310 may receive a search term that is used for a user to search for a desired location.

The search result list 320 and the search map box 330 may determine one of a target POI object corresponding to the search term entered in the input user search box 310 and a POI object having the input search term as its additional information to be a target POI object, and may indicate related POI objects corresponding to the target POI object using a POI group. The search result list 320 may indicate brief basic information and rating information related to related POI objects, and the search map box 330 may indicate the related POI objects, included in the search result list 320, on a map.

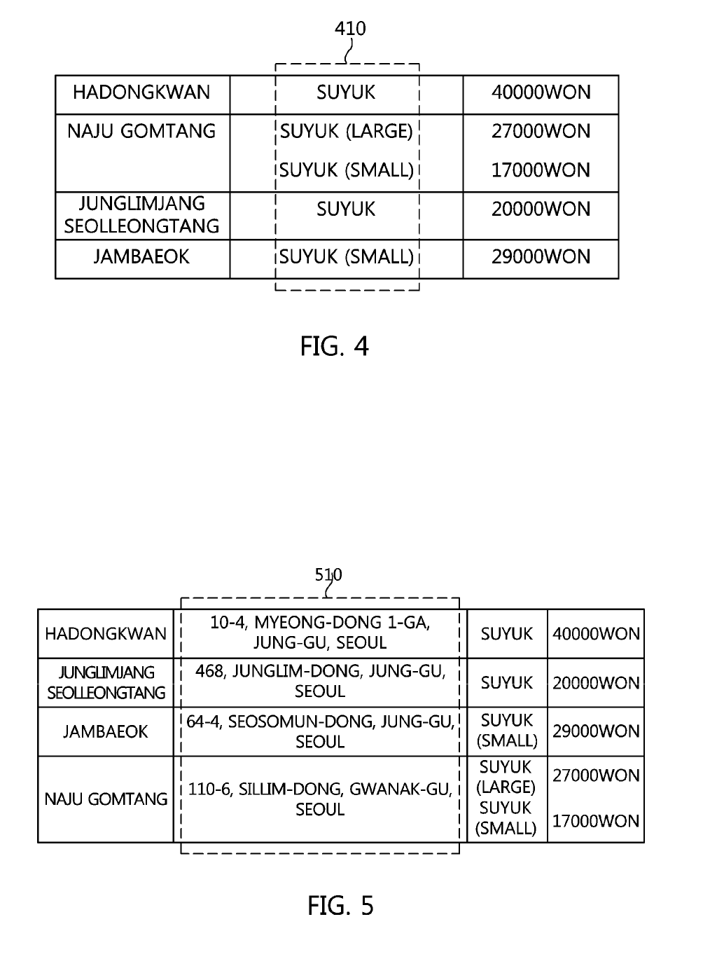

FIG. 4 is a diagram showing an example of related POI information for price comparison according to the present invention.

Referring to FIG. 4, related POI information for price comparison according to the present invention may indicate price information based on additional information 410. In FIG. 4, related POI objects are extracted and indicated for a target POI object corresponding to additional information “Suyuk (boiled beef or pork slices)” in response to a request from a user.

In this case, information about price comparison between restaurants which sell the same food menu by indicating the price information together with the additional information. The above price comparison information is acquired and additionally transmitted to the user, and thus the user can select a restaurant in a price span determined to be suitable for the user and also information about the corresponding menu can be acquired in advance, thereby assisting in planning a budget.

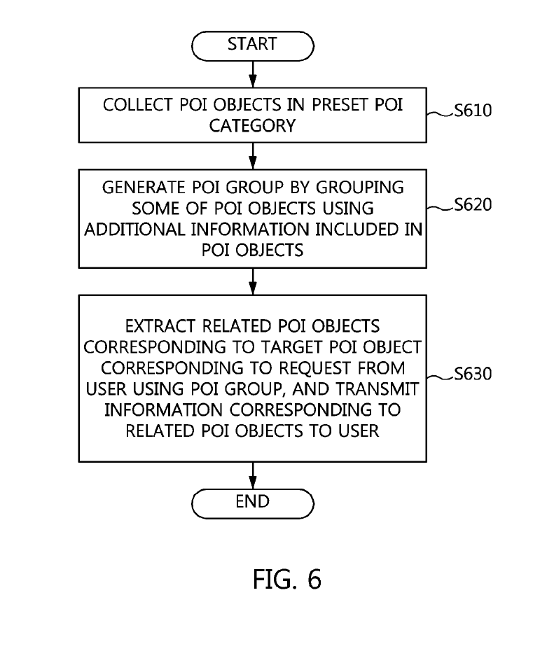

FIG. 5 is a diagram showing an example of related POI information for distance comparison according to the present invention.

Referring to FIG. 5, related POI information for distance comparison according to the present invention may indicate address information that may be included in basic information based on additional information 510. In FIG. 5, related POI objects may be extracted and indicated for a target POI object corresponding to the additional information “Suyuk” in response to a request from a user.

In this case, the locations of restaurants which sell the same food menu can be determined by indicating the address information together with the additional information, thereby acquiring information about distances to the user. The above distance information is acquired and additionally transmitted to the user, and thus the user can select a restaurant closest to a current location. Furthermore, the price information together with the distance information is indicated, thereby enabling the user to select a restaurant by determining the distance and price information.

As described above, when related POI information is transmitted to the user, basic information indicating information about POI objects and additional information are indicated together, thereby providing various types of information so that the user can select a more appropriate location.

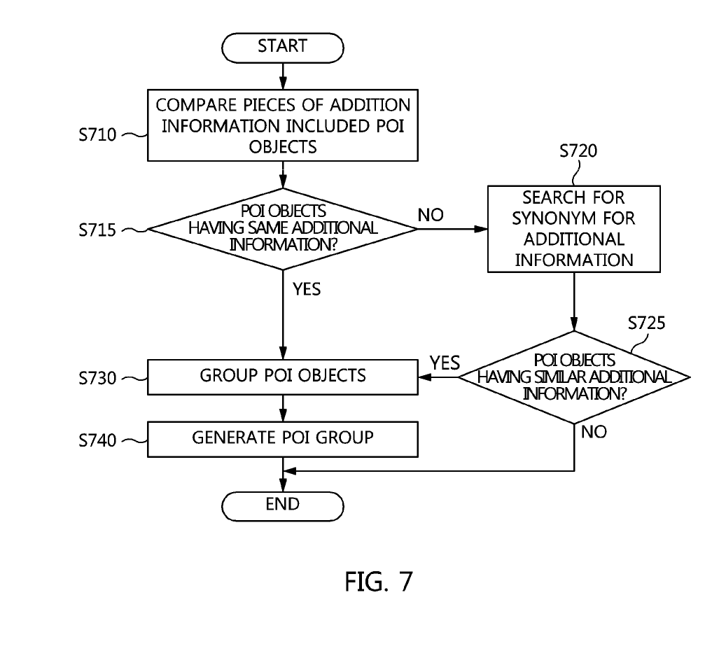

FIG. 6 is an operation flowchart showing a method of providing POI information according to an embodiment of the present invention.

Referring to FIG. 6, in the method of providing POI information according to an embodiment of the present invention, POI objects may be collected in preset POI category at step S610. For example, POI objects related to restaurants may be collected in a restaurant category, and POI objects related to general hospitals or private hospitals may be collected in a hospital category.

Furthermore, in the method of providing POI information according to an embodiment of the present invention, a POI group may be generated by grouping some of POI objects using additional information included in each of the POI objects. The grouping refers to arranging data having a common feature in a related group. A POI group may be generated by grouping POI objects having common additional information. In this case, the additional information may be information about the content of POI objects based on the type of preset POI category.

In this case, one or more of POI objects having the same additional information and POI objects having similar additional information may be extracted from POI objects by comparing pieces of additional information included in the respective POI objects, and then may be grouped. For example, when POI objects including “seolleongtang (an ox bone soup)” as additional information are grouped among POI objects in a restaurant category, one or more POI objects including “seolleongtang” in their additional information and one or more POI objects including the synonym “seolnongtang” in their additional information may be extracted and grouped together.

In this case, a synonym related to additional information may be searched for using a thesaurus, and POI objects including the synonym in their additional information may be determined to be POI objects having similar additional information.

Furthermore, in the method of providing POI information according to an embodiment of the present invention, related POI objects corresponding to a target POI object corresponding to a request from a user may be extracted using a POI group and information corresponding to the related POI objects may be transmitted to the user at step S630. For example, when a target POI object corresponding to a request from a user is a restaurant related POI object including “seolleongtang” as its additional information, a related POI may be extracted from POI objects included in a POI group grouped using additional information as “seolleongtang.” Furthermore, a related POI may be extracted from POI objects included in a POI group grouped using “seolnongtang,” i.e., a synonym for “seolleongtang,” as additional information.

In this case, at least one or more object close to the current location of the user among related POI objects may be recommended using the basic information of the related POI objects. For example, information about the distances between each of the related POI objects and the user may be calculated by acquiring the coordinate or address information of POIs included in the basic information of the extracted related POI objects and then acquiring the current location of the user from the user terminal device 110. Since most users chiefly search for destinations close to their current locations when searching for locations, it may be possible to calculate distance information and then recommend related POIs to the user in order of proximity.

In this case, at least one or more of price comparison information and preference ranking information may be generated for the related POI objects, and may be provided to the user. For example, related POI objects for the additional information “seolleongtang” may be extracted in response to a request from the user, and price information may be also provided when related POI information is provided based on additional information, thereby enabling the user to compare prices in restaurants which sell the same “seolleongtang.” Furthermore, related POIs may be provided in order of preference using information about ratings which users have assigned to respective POI objects, thereby enabling a user to receive information about restaurants having high preferences among restaurants which sell the same “seolleongtang.”

In this case, a related POI list may be generated using at least one or more of the basic information and additional information of the related POI objects, and at least one or more of the price comparison information and the preference ranking information may be generated using the related POI list. The related POI list is a list indicating information based on the basic information and additional information of the related POI objects based on the additional information. For example, address information or coordinate information included in the basic information may be indicated in a list prepared based on additional information for the food menu or price information, ingredient information or the like for a food menu, i.e., additional information, may be indicated in the list, thereby enabling users to make selection based on various types of information when selecting locations.

In this case, the basic information may be information about POI objects, and the additional information may be information about the content of the POI objects based on the type of preset POI category. For example, the basic information may be information about the coordinate information object category of POI objects and information about object attributes, and the additional information may be menu information in the case of a restaurant category, a medical field in the case of a hospital category and product-on-sale information in the case of a store category, based on the category of a POI object.

Price comparison information, same business field ranking information and the like are extracted using the above method of providing POI information, and thus the extracted information can be effectively used for sales marketing.

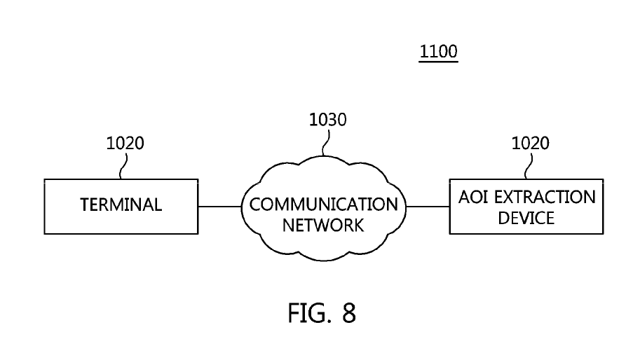

FIG. 7 is an operation flowchart showing a POI grouping method according to an embodiment of the present invention.

Referring to FIG. 7, in the POI grouping method according to the embodiment of the present invention, additional information included in each of collected POI objects may be determined at step S710.

Furthermore, in the POI grouping method according to the embodiment of the present invention, it may be determined whether the pieces of additional information of the POI objects are the same at step S715.

If, as a result of the determination at step S715, the pieces of additional information of the POI objects are not the same, a synonym for the additional information may be searched for at step S720.

Furthermore, in the POI grouping method according to the embodiment of the present invention, it may be determined whether the pieces of additional information of the POI objects are similar at step S725.

If, as a result of the determination at step S715, the pieces of additional information of the POI objects are the same or if, as a result of the determination at step S725, the pieces of additional information of the POI objects are similar, corresponding POI objects may be grouped at step S730.

Furthermore, in the POI grouping method according to the embodiment of the present invention, a POI group may be generated through the grouping of the POI objects at step S740.

The method of providing POI information according to the present invention may be implemented in the form of program instructions, and may be recorded on a computer-readable storage medium. The computer-readable storage medium may include program instructions, data files, and data structures solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media such as a hard disk, a floppy disk and magnetic tape, optical media such as compact disk (CD)-read only memory (ROM) and a digital versatile disk (DVD), magneto-optical media such as a floptical disk, and semiconductor devices such as ROM, random access memory (RAM) and flash memory. Examples of the program instructions include machine code, such as code created by a compiler, and high-level language code executable by a computer using an interpreter. These hardware devices may be configured to operate as one or more software modules in order to perform the operation of the present invention, and the vice versa.

The device and method for providing POI information using POI grouping according to the present invention are not limited to the configurations and methods of the above-described embodiments, but some or all of the embodiments may be configured to be selectively combined such that the embodiments can be modified in various manners.

Now, a method of extracting an AOI using a POI distribution chart and a device and system using the same according to embodiments of the present invention will be described in detail below with reference to the accompanying drawings. In this case, the same reference symbols will be assigned to components having similar functions and operations throughout the drawings, and redundant descriptions thereof will be omitted.

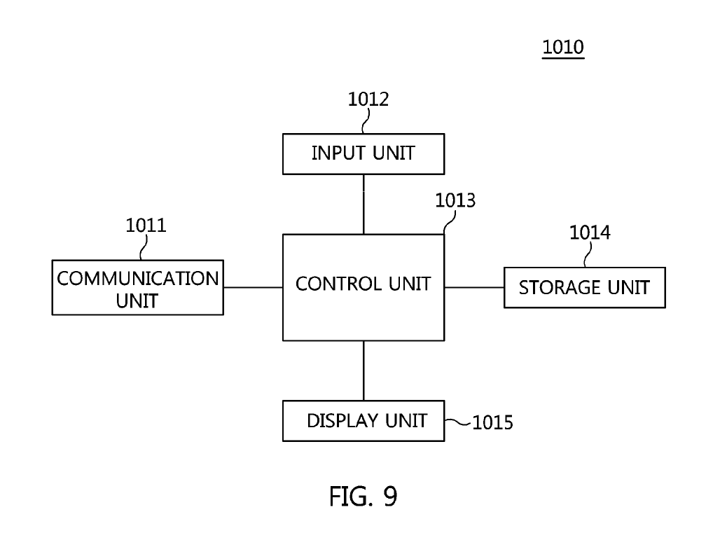

FIG. 8 is a diagram schematically showing the configurations of the principal components of a system for extracting an AOI using a POI distribution chart according to an embodiment of the present invention.

Referring to FIG. 8, the system 1100 for extracting an AOI using a POI distribution chart according to the embodiment of the present invention may include a terminal 1010, an AOI extraction device 1020, and a communication network 1030 configured to support the transmission and reception of information between the terminal 1010 and the AOI extraction device 1020.

The individual components are schematically described as follows. First, the terminal 1010 refers to a device of a user that can transmit and receive various types of data over the communication network 1030 in response to the manipulation of the user. The terminal 1010 may perform voice or data communication over the communication network 1030, and may transmit and receive various types of information to and from the AOI extraction device 1020. For this purpose, the terminal 1010 of the present invention may include a browser configured to transmit and receive information, memory configured to store programs and protocols, and a microprocessor configured to execute various types of programs and perform operations and control.

In particular, the terminal 1010 according to an embodiment of the present invention may be based on a concept including both a terminal of the user who desires to use an area-of-interest service using a POI distribution chart and a terminal of an administrator who desires to extract an AOI using a POI distribution chart. In this case, when the terminal 1010 is the terminal of the administrator who desires to extract an AOI using a POI distribution chart, the terminal 1010 may function to transmit a keyword corresponding to a specific area, input by the user, to the AOI extraction device 1020, or may function to support the input of the user for various setting conditions used to extract an AOI using a POI distribution chart. In contrast, when the terminal 1010 is the terminal of the user who desires to use an area-of-interest service using a POI distribution chart, the terminal 1010 transmits a keyword corresponding to a specific area, input by the user, to the AOI extraction device 1020 in order to determine an AOI, or receives information about the AOI and various types of additional information from the AOI extraction device 1020, thereby enabling the use of various services supported by the AOI extraction device 1020.

The AOI extraction device 1020 functions to extract and manage an AOI using the POI distribution chart of the present invention. In particular, the AOI extraction device 1020 functions to determine location coordinates set for a keyword input in accordance with a specific area, to calculate a POI (Point Of Interest) distribution chart with the determined location coordinates as its center, to determine an area where the number of POIs is equal to or larger than a predetermined value to be an AOI based on the calculated POI distribution chart, and to manage the AOI.

Furthermore, even when a particular keyword is not input by the user, the AOI extraction device 1020 may calculate a POI distribution chart in accordance with a specific area at predetermined periods, may determine an area where the number of POIs is equal to or larger than a predetermined value to be an AOI based on the calculated POI distribution chart, and may set the AOI as a recommended area when the set AOI is a recently set AOI.

The more detailed principal configurations and operation method of the AOI extraction device 1020 will be described later. A processor installed in each of the terminal 1010 and the AOI extraction device 1020 according to the embodiment of the present invention may process program instructions adapted to execute the method according to the present invention. In an implementation, this processor may be a single-threaded processor. In another implementation, the processor may be a multi-threaded processor. Furthermore, the processor can process instructions stored in memory or a storage device.

Furthermore, the terminal 1010 and the AOI extraction device 1020 according to the embodiment of the present invention transmit and receive various types of related information over the communication network 1030. In this case, various types of communication networks may be used as the communication network 1030.

For example, the communication network 1030 may use wireless communication methods, such as wireless LAN (WLAN), Wi-Fi, Wibro, Wimax and High-Speed Downlink Packet Access (HSDPA) methods, or wired communication methods, such as Ethernet, xDSL (ADSL and VDSL), Hybrid Fiber Coax (HFC), Fiber To The Curb (FTTC) and Fiber To The Home (FTTH) methods. Furthermore, the communication network 1030 may use all types of communication methods that have been widely known or that will be developed in the future, as well as the above-described communication methods.

The principal configurations and operation method of the terminal 1010 according to the embodiment of the present invention are described below.

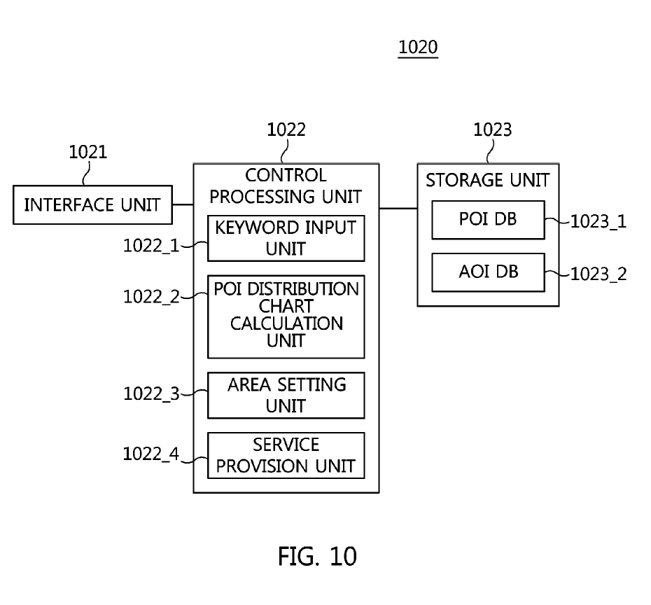

FIG. 9 is a block diagram showing the principal configurations of the terminal according to the embodiment of the present invention, which is shown in FIG. 8.

Referring to FIGS. 8 and 9, the terminal 1010 according to the embodiment of the present invention may include a communication unit 1011, an input unit 1012, a control unit 1013, a storage unit 1014, and a display unit 1015.

The individual components are described in detail as follows. First, the communication unit 1011 functions to support the transmission and reception of various types of information to and from the AOI extraction device 1020 over the communication network 1030. In particular, the communication unit 1011 according to an embodiment of the present invention may function to transmit various types of information input by the user, for example, a keyword input in accordance with a specific area, to the AOI extraction device 1020, and to receive an AOI for the keyword from the AOI extraction device 1020.

The input unit 1012 transfers various types of information, such as numerical and textual information, input by the user and signals input in connection with various types of function settings and the functional control of the terminal 1010 to the control unit 1013. In particular, the input unit 1012 of the present invention may support the input of a keyword in accordance with a specific area.

The input unit 1012 may include a key entry means such as a keyboard or keypad, a touch input means such as a touch sensor or touch pad, a voice input means, and a gesture input means including at least one or more of a gyro sensor, a terrestrial magnetism sensor, an accelerator sensor, a proximity sensor and a camera, as described above.

In addition, the input unit 1012 may include all types of input means that are being developed or that will be developed in the future.

The control unit 1013 performs the overall control of the terminal 1010. In terms of hardware, the control unit 1013 may include: at least one processor configured to include a Central Processing Unit (CPU)/Micro Processing Unit (MPU); execution memory, for example, a register and/or Random Access Memory (RAM), configured such that at least one or more pieces of memory loading data are located thereon; and a bus configured to input/output at least one or more pieces of data to the processor and the memory. Furthermore, in terms of software, the control unit 1013 may include a predetermined program routine or program data that is loaded from a predetermined storage medium to the execution memory in order to perform a function (for example, the function of extracting an AOI) defined in the terminal 1010 and that is then processed by the processor. In other words, elements that belong to functions provided in the terminal 1010 in order to process the method of executing an AOI according to the embodiment of the present invention and that can be processed by software may be determined to be functions of control unit 1013.

The control unit 1013 of the present invention is functionally connected to at least one or more provided components. That is, the control unit 1013 is functionally connected to the communication unit 1011, the input unit 1012, the storage unit 1014 and the display unit 1015, and controls the supply of power to the individual components and the flow of signals for the performance of functions.

In particular, when the terminal 1010 is a terminal of a user who desires to use the method of extracting an AOI using a POI distribution chart according to the present invention, the control unit 1013 may control the process of transmitting a keyword to the AOI extraction device 1020 via the communication unit 1011 when the keyword corresponding to a specific area input by the user is transferred from the input unit 1012. Furthermore, control unit 1013 may control the overall process of receiving data on an AOI, set in accordance with the keyword, from the AOI extraction device 1020 via communication unit 1011 and displaying the received data via the display unit 1015.

Furthermore, when the terminal 1010 is a terminal of an administrator who sets and manages an AOI using the POI distribution chart of the present invention, the control unit 1013 may transmit a keyword for a specific area, input via the input unit 1012, to the AOI extraction device 1020 via the communication unit 1011, may receive a corresponding result from the AOI extraction device 1020 via the communication unit 1011. Furthermore, the control unit 1013 may function to calculate a POI distribution chart at predetermined periods, to transmit a plurality of control instructions to periodically set an AOI to the AOI extraction device 1020 via the communication unit 1011, and to request the AOI extraction device 1020 that specific information is transmitted to a terminal of another user who desires to use the method of executing an AOI.

The storage unit 1014 may temporarily store not only an application program required for an operation according to an embodiment of the present invention function but also various pieces of data generated during the execution of the application program. The storage unit 1014 may basically include a program area and a datan area. The program area stores related information for the driving of the terminal 1010, such as an operating system (OS) used to boot up the terminal 1010. The datan area refers to an area where data generated according to the use of the terminal 1010 is stored. The storage unit 1014 may include a storage medium, such as flash memory, a hard disk, multimedia card micro type memory (e.g., SD or XD memory), RAM, and/or ROM.

The display unit 1015 displays information about a series of operating states and a series of operation results that are generated during the performance of the functions of the terminal 1010. In particular, the display unit 1015 of the present invention may support a series of processes of displaying a result for an AOI with the result mapped to a map.

The display unit 1015, together with the input unit 1012, may be implemented in the form of a single touch panel or touch screen, as described above. When the display unit 1015 is implemented along with the input unit 1012, various types of information generated in response to the touch operations of the user may be displayed.

Furthermore, the above-described display unit 1015 of the present invention may include a liquid crystal display (LCD), a thin film transistor LCD (TFT-LCD), organic light emitting diodes (OLEDs), light-emitting diodes (LEDs), active matrix organic LEDs (AMOLEDs), a flexible display, and a three-dimensional display. Furthermore, some of these displays may be configured in a transparent or light-transmission form so that the outside can be viewed through them. In this case, these displays may be configured in the form of transparent displays including transparent OLEDs (TOLEDs).

As described above, the principal components of the terminal 1010 have been described via FIG. 9. However, all the components shown via FIG. 9 are not essential components. The terminal 1010 may be implemented using a number of components larger than the number of shown components, or may be implemented using a number of components smaller than the number of shown components. For example, the terminal 1010 may further include a source sound output unit (not shown) that converts a source sound, i.e., an electrical signal, into an analog signal and then outputs the analog signal. Furthermore, it will be apparent that the locations of the principal components of the terminal 1010 shown via FIG. 9 may be changed for convenience or for another reason.

The principal configurations and operation method of the terminal 1010 according to the embodiment of the present invention have been described above. The terminal 1010 of the present invention may be implemented in various forms. For example, not only a mobile terminal, such a smart phone, a tablet PC, a Personal Digital Assistant (PDA), a Portable Multimedia Player (PMP) or an MP3 Player but also a fixed terminal, such as a smart TV or a desktop computer, may be used as the terminal 1010 described herein.

Although all the devices that can be used as the terminal 1010 of the present invention cannot be listed because the modifications of mobile devices are very various due to a tendency toward the convergence of digital devices, a unit of a level equivalent to the level of the above-described units may be used as the terminal 1010 according to the present invention. Any device may be used as the terminal 1010 of the present invention as long as the device is a terminal that can transmit and receive information to and from the AOI extraction device 1020 over the communication network 1030.

The principal configurations and operation method of the AOI extraction device 1020 according to an embodiment of the present invention are described below.

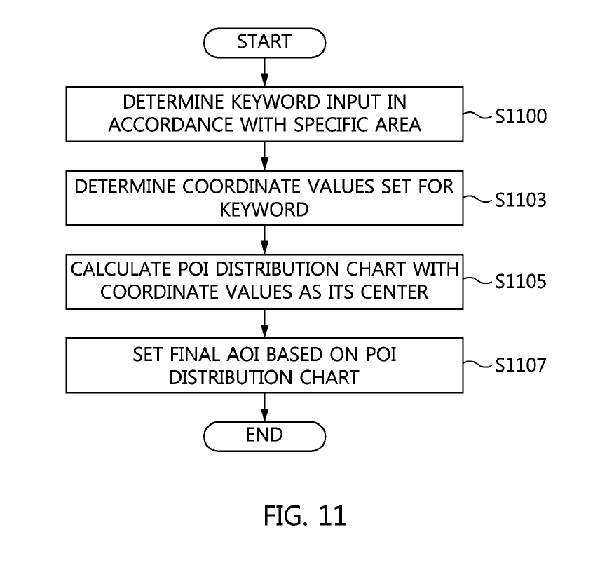

FIG. 10 is a block diagram showing the principal configurations of the AOI extraction device according to the embodiment of the present invention, which is shown in FIG. 8.

Referring to FIGS. 8 and 10, the AOI extraction device 1020 according to the embodiment of the present invention may include an interface unit 1021, a control processing unit 1022, and a storage unit 1023.

The individual components are described in detail as follows. First, the interface unit 1021 supports the function of transmitting and receiving various types of information to and from one or more terminals 1010 over the communication network 1030. In particular, the interface unit 1021 of the present invention may receive a keyword, input in accordance with a specific area, from any one terminal 1010. Furthermore, the result of an AOI for the area may be provided to the terminal 1010.

The control processing unit 1022 performs the overall control of the AOI extraction device 1020 according to the embodiment of the present invention. In particular, the control processing unit 1022 according to the embodiment of the present invention may perform various types of control for the method of extracting an AOI using a POI distribution chart according to the present invention. The control processing unit 1022 may include a keyword input unit 1022_1, a POI distribution chart calculation unit 1022_2, an area setting unit 1022_3, and a service provision unit 1022_4.

First, the keyword input unit 1022_1 functions to determine a keyword input in accordance with a specific area. In this case, in the process of determining the keyword input in accordance with the specific area, a keyword received from any one terminal or a keyword previously designated by an administrator may be determined.

When the keyword is transferred from the keyword input unit 1022_1, the POI distribution chart calculation unit 1022_2 may determine location coordinates set in accordance with the keyword, and may calculate a POI distribution chart with the determined location coordinates as its center. In this case, the POI distribution chart calculation unit 1022_2 may determine whether there is a synonym preset in accordance with the keyword, and, if there is a synonym, may determine location coordinates set for the synonym and calculate a POI distribution chart by considering all the location coordinates.

For example, when the determined keyword is Namdaemun (the Great South Gate of Seoul), the POI distribution chart calculation unit 1022_2 determines 37° 33′36.11″ N and 126° 58′31.26″ E, i.e., the location coordinates of Namdaemun. Furthermore, a POI distribution chart is calculated by moving a predetermined size scan area from first location coordinates, corresponding to a north latitude and a west latitude determined using the north latitude coordinate values of the location coordinates, to second location coordinates, corresponding to a south latitude and an east latitude determined using the east latitude coordinate values of the location coordinates. Furthermore, the POI distribution chart calculation unit 1022_2 of the present invention may calculate a POI distribution chart for a specific area at predetermined periods.

The area setting unit 1022_3 may set an AOI in accordance with the POI distribution chart calculated by the POI distribution chart calculation unit 1022_2. In this case, the area setting unit 1022_3 may connect the outermost coordinates of a POI based on the POI distribution chart and set the connected area as an AOI, i.e., an Area Of Interest (AOI). Furthermore, the area setting unit 1022_3 may store information, mapped to the POI included in the connected area, with the information being mapped to the AOI. The information mapped to the POI may be a name, a category, or other various types of additional information related to the point, and the area setting unit 1022_3 may use the information mapped to the POI included in the area without separately setting related information for the AOI. Furthermore, the area setting unit 1022_3 of the present invention may set the set AOI as a recommended area when the set AOI is a recently set AOI.

The service provision unit 1022_4 may function to provide the set AOI and the information mapped to the AOI to a specific terminal in response to a request from the corresponding terminal.

The method of extracting an AOI using a POI distribution chart in the control processing unit 1022 is described in detail below.

The storage unit 1023 stores all programs related to the execution of the function of the AOI extraction device 1020. In particular, the service storage unit 1022 according to the present invention may include a POI DB 1023_1 and an AOI DB 1023_2. In this case, the POI DB 1023_1 refers to a database previously constructed using various methods. In contrast, the AOI DB 1023_2 refers to a database for AOIs extracted using the POI data of the POI DB 1023_1.

The storage unit 1023 of the present invention may be storage located within the AOI extraction device 1020, or may be a data storage server located outside the AOI extraction device 1020 and configured to enable data transmission and reception to and from the AOI extraction device 1020.

The principal configurations and operation method of the AOI extraction device 1020 according to the embodiments of the present invention have been described above.

In terms of hardware, the AOI extraction device 1020 according to the embodiment of the present invention has the same configuration as a common web server or network server. However, in terms of software, the AOI extraction device 1020 includes program modules implemented using a language, such as C, C++, Java, Visual Basic, or Visual C. The AOI extraction device 1020 may be implemented in the form of a web server or network server. The web server refers to a computer system generally connected to a plurality of unspecified clients and/or another server over an open computer network, such as the Internet, and configured to receive a request for the performance of a task from a client or the other web server, obtain the result of the task, and provide the result of the task, and computer software (a web server program) installed for the computer system. However, the web server must be understood as being based on a broad concept including a series of application programs running on the web server in addition to the above-described web server program, and, in some cases, also including various types of databases. The AOI extraction device 1020 may be implemented in general hardware for a server using one of web server programs that are variously provided based on OSs, such as DOS, Windows, Linux, UNIX, and Macintosh. Representatively, Website and Internet Information Server (IIS) used in a Windows environment and CERN, NCSA and APPACH used in a UNIX environment may be used. Furthermore, the AOI extraction device 1020 may classify service subscription information, and may store and manage the classified information in a membership database. The database may be implemented inside or outside the AOI extraction device 1020. In this case, the database implemented inside the AOI extraction device 1020 may be the storage unit 1023.

Furthermore, the AOI extraction device 1020 of the present invention may be implemented as one or more servers that operate according to a server-based computing method or cloud method. In particular, the information transmitted and received via the system 1100 for extracting an AOI may be provided via a cloud computing function that may be permanently stored in a cloud computing device over the Internet. In this case, the cloud computing refers to a technology for serving Information Technology (IT) resources, for example, hardware (a server, a storage, a network, etc.), software (a database, security, a web server, etc.), service, data, virtualized using Internet technology, to digital terminals, such as desktops, tablet computers, notebooks, netbooks and smart phones, in an On demand manner. In the present invention, all information transmitted and received between the one or more terminals 1010 and the AOI extraction device 1020 may be stored in a cloud computing device over the Internet, and may be transmitted anywhere and at any time.

Meanwhile, memory installed in the terminal 1010 or AOI extraction device 1020 stores information within the device. In an implementation, the memory is a computer-readable medium. The memory may be a volatile memory unit in an implementation, and may be a nonvolatile memory unit in another implementation. In an implementation, the storage device is a computer-readable medium. In various different implementations, the storage device may include, for example, a hard disk device, an optical disk device, or any other mass storage device.

Although the illustrative configuration of the apparatus has been shown in the present specification and the attached drawings, the functional operations and the implementations of the subject matter described in the present specification may be implemented in different types of digital electronic circuits, and may be implemented in the form of computer software, firmware, or hardware including the structures disclosed in the present specification and structural equivalents thereof or may be implemented by a combination of one or more thereof. The implementations of the subject matter described in the present specification may be implemented as one or more computer program products, i.e., one or more modules regarding computer program instructions encoded on a tangible storage medium in order to control the operations of the apparatus according to the present invention or perform execution based on the operations. The computer-readable medium may be a machine-readable storage device, a machine-readable storage board, a memory device, or a composition of substances influencing machine-readable radio wave-type signals, or a combination of one or more thereof

A method of extracting an AOI using a POI distribution chart according to an embodiment of the present invention is described below.

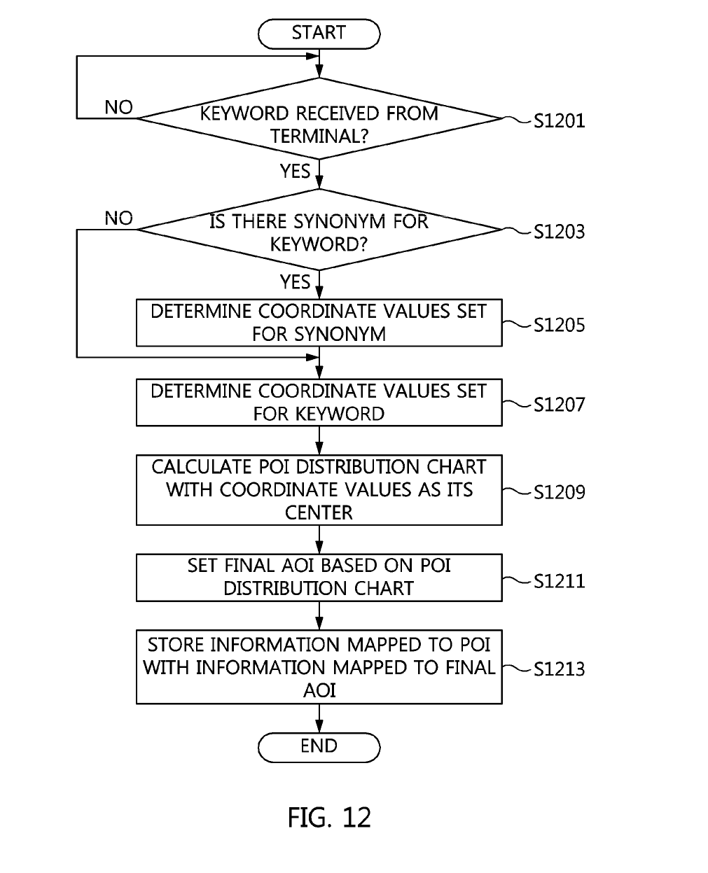

FIG. 11 is a flowchart illustrating the method of extracting an AOI using a POI distribution chart according to the embodiment of the present invention.

Referring to FIG. 11, first, the AOI extraction device 1020 according to the embodiment of the present invention determines a keyword input in accordance with a specific area at step S1101.

Furthermore, the AOI extraction device 1020 determines location coordinates set in accordance with the keyword at step S1103, and calculates a POI distribution chart with the determined location coordinates as its center at step S1105.

Thereafter, the AOI extraction device 1020 sets an AOI in accordance with the POI distribution chart at step S1107.

The individual processes are described in detail below.

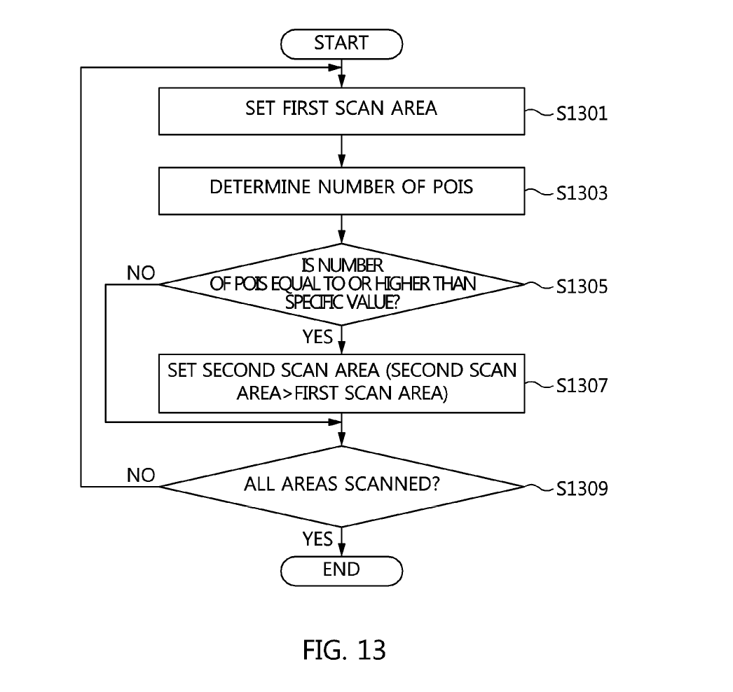

FIG. 12 is a flowchart illustrating a method of extracting an AOI using a POI distribution chart according to an embodiment of the present invention in greater detail.

Referring to FIGS. 11 and 12, the step of determining a keyword input in accordance with the specific area, which is shown in FIG. 11, may be achieved in such a manner that the AOI extraction device 1020 receives a keyword, input in accordance with the specific area, from any one terminal 1010 at step S1201, as shown in FIG. 12. Furthermore, the keyword input in accordance with the specific area may be a keyword previously designated by an administrator.

In this case, the terminal 1010 may be a terminal of a user who desires to use the area-of-interest service using a POI distribution chart according to the present invention, and may be a terminal of an administrator who desires to extract an AOI using a POI distribution chart.

The keyword input in accordance with the specific area and received from the terminal 1010 may be a keyword for a well-known name, for example, Myeong-dong, Namdaemun, Eulji-ro, or the like.

Thereafter, the AOI extraction device 1020 determines whether there is a synonym preset in accordance with the keyword at step S1203.

For example, the area “Myeong-dong” may be used to refer to an area, including a set of a plurality of administrative areas, rather than a specific point. For example, Myeong-dong may be a set of Mugyo-dong, Da-dong, Taepyeong-ro 1-ga, Eulji-ro 1-ga, Eulji-ro 2-ga, Namdaemun-ro 1-ga, Samgak-dong, Suha-dong, Janggyo-dong, Supyo-dong, Hoehyeon-dong 3-ga, Chungmu-ro 2-ga, Myeong-dong 1-ga, Myeong-dong 2-ga, Namsan-dong 1-ga, Namsan-dong 2-ga, Namsan-dong 3-ga, and Jeo-dong 1-ga. Furthermore, Myeong-dong is not an official name, and another nickname that is widely used by users may be present.

As described above, the AOI extraction device 1020 may perform the step of determining whether there is a synonym for the keyword received from the terminal 1010 in the state in which one or more synonyms including the name of a related administrative address corresponding to each specific area have been previously stored for each keyword correspond to the specific area at step S1203.

If, as a result of the determination, there is a synonym set for the keyword, the AOI extraction device 1020 determines location coordinates set for the synonym and location coordinates set for the keyword.

Thereafter, the AOI extraction device 1020 calculates a POI distribution chart with the determined location coordinates as its center at step S1209.

For example, when the keyword input by the terminal 1010 is Namdaemun, the AOI extraction device 1020 determines 37° 33′36.11″ N and 126° 58′31.26″ E, i.e., the location coordinates of Namdaemun. Furthermore, a POI distribution chart is calculated by moving a predetermined size scan area from first location coordinates, corresponding to a north latitude and a west latitude determined using the north latitude coordinate values of the location coordinates, to second location coordinates, corresponding to a south latitude and an east latitude determined using the east latitude coordinate values of the location coordinates.

Thereafter, the AOI extraction device 1020 may set an AOI in accordance with the POI distribution chart at step S1211. In this case, the AOI extraction device 1020 may connect the outermost coordinates of the POI in accordance with the POI distribution chart and then set the connected area as an AOI, i.e., an Area Of Interest (AOI).

Furthermore, the AOI extraction device 1020 may store information, mapped to the POI included in the connected area, with the information mapped to the AOI at step S1213. The information mapped to the POI may be a name, a category, or other various types of additional information related to the point, and the AOI extraction device 1020 may use the information mapped to the POI included in the area without separately setting related information for the AOI.

The process of calculating a POI distribution chart according to an embodiment of the present invention is described in greater detail below.

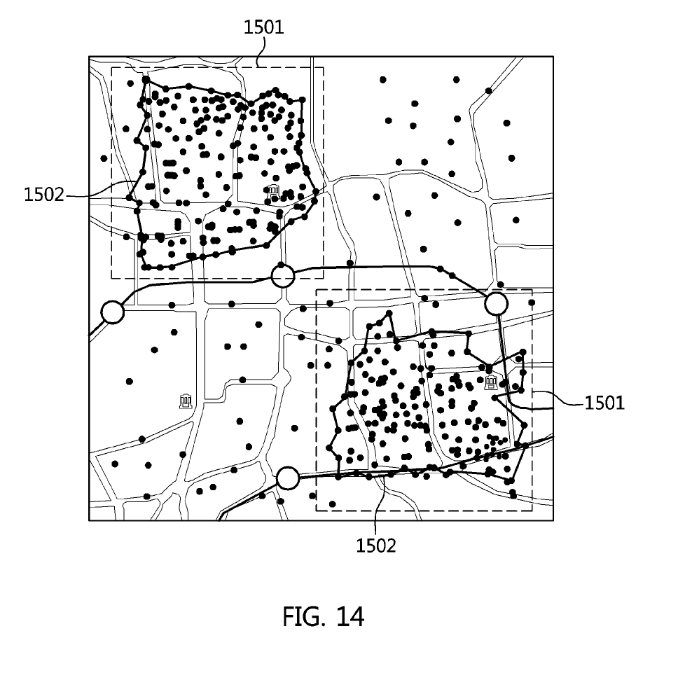

FIG. 13 is a flowchart illustrating a method of calculating a POI distribution chart according to an embodiment of the present invention in greater detail.

Referring to FIG. 13, as described above, the AOI extraction device 1020 sets a first scan area based on location coordinates after determining the location coordinates at step S1301.

For example, when the keyword input by the terminal 1010 is Namdaemun, the AOI extraction device 1020 may determine 37° 33′36.11″ N and 126° 58′31.26″ E, i.e., the location coordinates of Namdaemun, and may set a predetermined size scan area at first location coordinates corresponding to a north latitude and a west latitude determined using the north latitude coordinate values of the location coordinates.

In this case, the size of the scan area may vary depending on the size of a specific area corresponding to the keyword. In other words, when the specific area corresponding to the keyword corresponds to a specific location, such as Namdaemun, Namdaemun refers to a point, and thus the AOI extraction device 1020 may set a first scan area to a small area. In contrast, when the specific area corresponding to the keyword is based on a concept including a specific range, such as Myeong-dong, the AOI extraction device 1020 may set the first scan area to an area larger than that for Namdaemun.

Thereafter, the AOI extraction device 1020 sets the first scan area at the first location coordinates and then determines the number of POIs included in the first scan area at step S1303. Furthermore, the AOI extraction device 1020 determines whether the number of POIs included in the first scan area is equal to or larger than a predetermined value at step S1305.

The predetermined value may be the average number of POIs. In this case, the average number of POIs may be a value obtained by dividing the number of POIs, located within the Namdaemun area, by the size of the first scan area in the above-described example. That is, assuming that the area of Namdaemun is 100 m² and the number of POIs located within the Namdaemun area is 500, the average number of POIs of Namdaemun is 5. Furthermore, when the first scan area is 10 m² and the number of POIs included in the first scan area is 6, the AOI extraction device 1020 sets a second scan area to an area wider than that for the first scan area because the number of POIs included within the first scan area is equal to or larger than the average number of POIs. Thereafter, once all areas have been scanned by comparing the average numbers at step S1309, the AOI extraction device 1020 sets the corresponding second scan area as an AOI.

In this case, the AOI extraction device 1020 may set the AOI by connecting the outermost POIs of POIs located within the second scan area.

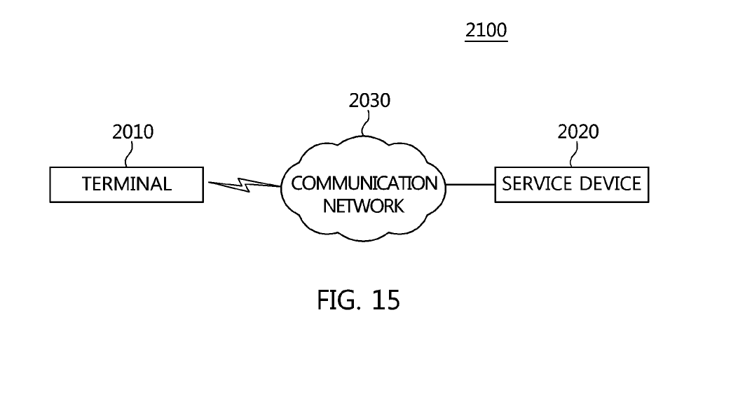

An example of such an AOI is shown in FIG. 14.

FIG. 14 is an exemplary screen shot illustrating a method of extracting an AOI using a POI distribution chart according to an embodiment of the present invention. As shown in FIG. 14, the AOI extraction device 1020 may extract an AOI 1502 by connecting POIs located within the second scan area 1501.

As described above, according to the method of extracting an AOI using a POI distribution chart according to the embodiment of the present invention, an AOI is extracted and managed using previously constructed POI data, thereby enabling the accurate extraction of an AOI without incurring additional costs for the extraction of the AOI.

Furthermore, according to the present invention, an area that has not been an AOI may be recommended as an AOI based on a POI distribution chart, a rising area or falling area may be expected based on changes in the POI distribution chart, and information about a business district based on a POI distribution chart may be extracted and provided to another system or the like.

The method of extracting an AOI using a POI distribution chart according to the embodiment of the present invention has been described above.

The above-described method of extracting an AOI using a POI distribution chart according to the present invention may be provided in the form of a computer-readable medium suitable for the storage of computer program instructions and data. In this case, the computer-readable medium suitable for the storage of computer program instructions and data, for example, a storage medium, includes magnetic media such as a hard disk, a floppy disk and a magnetic tape, optical media such as compact disk read only memory (CD-ROM) and a digital video disk (DVD), magneto-optical media such as a floptical disk, and semiconductor memory such as read only memory (ROM), random access memory (RAM), flash memory, erasable programmable ROM (EPROM) and electrically erasable programmable ROM (EEPROM). The processor and the memory may be supplemented by a special-purpose logic circuit, or may be integrated into a special-purpose logic circuit. Examples of the program instructions include machine code, such as code created by a compiler, and high-level language code executable by a computer using an interpreter. The hardware devices may be configured to operate as one or more software modules in order to perform the operations of the present invention, and the vice versa.

Although the present specification includes the details of a plurality of specific embodiments, the details should not be construed as limiting any invention or a scope that can be claimed, and on the contrary, the details should be construed as being descriptions of features that may be specific to the specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate lower-level combination. Furthermore, although features may operate in a specific combination and features may be initially depicted as being claimed, one or more features of a claimed combination may be excluded from the combination in some cases, and the claimed combination may be changed into a lower-level combination or a modification of the lower-level combination.

In the same manner, although operations are depicted in specific order in the drawings, it should not be understood that the operations must be performed in the depicted specific or sequential order or all the shown operations must be performed in order to obtain a preferred result. In a specific case, multi-tasking and parallel processing may be advantageous. Furthermore, it should not be understood that the separation of various system components of the aforementioned embodiments is required for all the embodiments. Rather, it should be understood that the aforementioned program components and systems may be integrated into a single software product or packaged into a multiple software product.

A system for measuring a distance on an electronic map according to an embodiment of the present invention is described below.

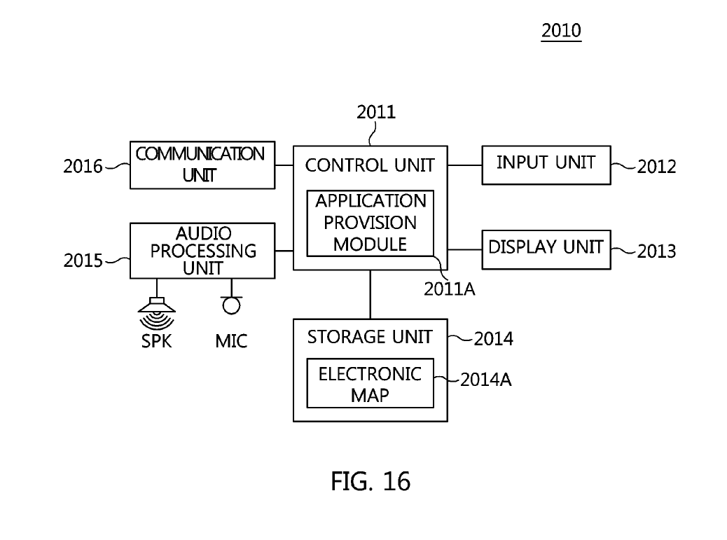

FIG. 15 is a diagram showing the configuration of the system for measuring a distance on an electronic map according to the embodiment of the present invention.

Referring to FIG. 15, the system 2100 for measuring a distance on an electronic map according to the embodiment of the present invention includes a terminal 2010, a service device 2020, and a communication network 2030.

A processor installed in the terminal 2010 or service device 2020 according to the embodiment of the present invention may process program instructions adapted to execute the method according to the present invention. In an implementation, this processor may be a single-threaded processor. In another implementation, the processor may be a multi-threaded processor. Furthermore, the processor can process instructions stored in memory or a storage device.

The communication network 2030 performs a series of data transmission and reception operations for the transmission of data and the exchange of information between the terminal 2010 and the service device 2020. In particular, various types of communication networks may be used as the communication network 2030. For example, the communication network 2030 may use wireless communication methods, such as wireless LAN (WLAN), Wi-Fi, Wibro, Wimax and High-Speed Downlink Packet Access (HSDPA) methods, or wired communication methods, such as Ethernet, xDSL (ADSL and VDSL), Hybrid Fiber Coax (HFC), Fiber To The Curb (FTTC) and Fiber To The Home (FTTH) methods. Meanwhile, the communication network 2030 may use all types of communication methods that have been widely known or that will be developed in the future, as well as the above-described communication methods.

The terminal 2010 is connected to the service device 2020 over the communication network 2030, and transmits and receives data for the measurement of a distance on an electronic map. In particular, when a map application is executed, the terminal 2010 according to the present invention displays an electronic map via the application. Furthermore, when a distance measurement function is selected, the terminal 2010 detects input signals adapted to sequentially select a plurality of points for the measurement of a distance, may connect the points, and determines the location information of each of the points.

The terminal 2010 calculates measured information by applying the determined location information, and outputs the calculated measured information onto an image of the electronic map. In this case, the measured information includes distance information adapted to connect the individual selected points on the electronic map and information about the time required to move from a start point to a destination point using a transportation means, such as walking, a bicycle, a private car, or a public transportation means.

Thereafter, the terminal 2010 determines changed location information when the location information of a specific one of a plurality of points is changed. Furthermore, the terminal 2010 modifies the measured information by applying the changed location information to a distance measurement function, and provides the modified measured information onto the image of the electronic map.

Furthermore, a terminal 2010 according to another embodiment of the present invention provides information for the measurement of a distance on the electronic map while operating in conjunction with the service device 2020. First, when a map application is executed, the terminal 2010 displays an electronic map via the map application. Furthermore, the terminal 2010 determines whether a plurality of points for the distance measurement function has been sequentially selected from the electronic map, determines the location information of the plurality of points in response to input selection signals, and transmits the location information to the service device 2020.

The terminal 2010 receives information about a distance generated by connecting the individual points and a transportation means from the service device 2020. Once the measured information has been received from the service device 2020, the terminal 2010 displays the measured information and the distance between the points on the electronic map. Thereafter, when an input signal adapted to change the location information of a specific one of the plurality of points is detected, the terminal 2010 transmits the input signal to the service device 2020.

Once the measured information to which the changed location information has been applied is received from the service device 2020, the terminal 2010 modifies and displays the measured information and the distance between points on the electronic map.

The service device 2020 is connected to the terminal 2010 over the communication network 2030, and transmits and receives data for the measurement of a distance on the electronic map. In particular, once information for the measurement of a distance provided via a map application and input onto the electronic map has been received from the terminal 2010, the service device 2020 according to the present invention determines the location information of the plurality of points based on the received information. Thereafter, the service device 2020 calculates measured information by applying the determined location information, and transmits the calculated measured information to the terminal 2010. In this case, the measured information includes distance information adapted to connect the individual selected points on the electronic map and information about the time required to move from a start point to a destination point using a transportation means, such as walking, a bicycle, a private car, or a public transportation means.

When an input signal adapted to change the location information of a specific one of the plurality of points displayed on the electronic map is received from the terminal 2010 after the measured information has been provided, the service device 2020 modifies the measured information by incorporating the changed location information into the measured information. Furthermore, the service device 2020 provides the modified measured information to the terminal 2010.

Using this, the present invention enables a user to freely modify a specific one of a plurality of points, displayed on the electronic map for the measurement of a distance, on the screen. Even when the user erroneously selects another point when the user measures a distance, a scale displayed on a screen can be repeatedly modified. Since a screen is intuitively changed, the measurement of a distance can be efficiently used. Furthermore, as the location of a specific point is changed on the electronic map, information about a distance and a transportation means is automatically changed and displayed on the image of the electronic map, thereby enabling the user to conveniently use the information.

Furthermore, the user can select the location of a specific point from the image of the electronic map, can incorporate the scale of an actual map into the map image, and can indicate the distance between the selected locations, a total distance, and the required time predicted when walking or a bicycle is used as images on the map. This can solve the problem in which, when a user measures a distance once and indicates the distance on a map image in a conventional distance measurement function, the indicated distance cannot be modified. A user can directly modify a distance indicated on the image of the electronic map, and can change a scale. Furthermore, the distance between changed locations, a total distance, and the required time predicted when walking or a bicycle is used can be automatically incorporated and immediately indicated as images on the map.

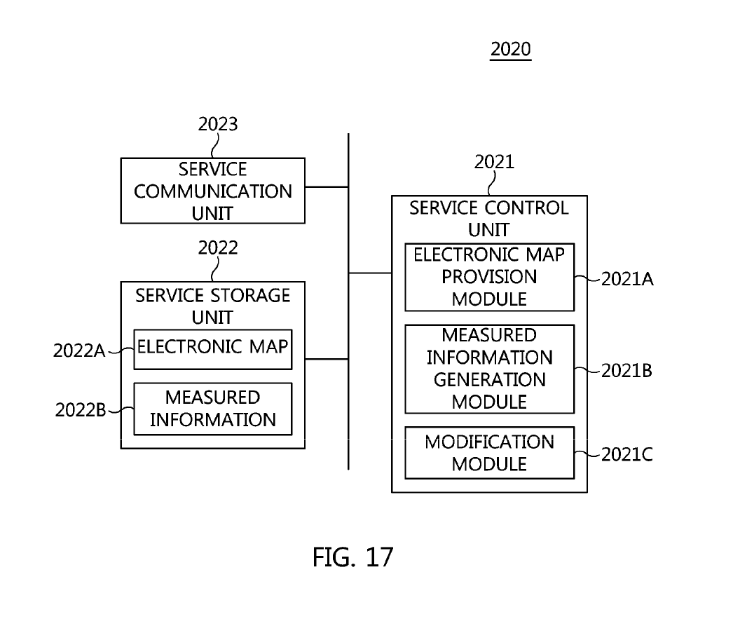

The above-described process of measuring a distance on an electronic map according to the embodiment of the present invention is described in greater detail below with reference to FIGS. 16 to 21B.

FIG. 16 is a block diagram showing the configuration of the terminal according to the present invention.

Referring to FIG. 16, the terminal 2010 according to the present invention includes a control unit 2011, an input unit 2012, a display unit 2013, a storage unit 2014, an audio processing unit 2015, and a communication unit 2016. In this case, the control unit 2011 includes an application provision module 2011A, and the storage unit 2014 includes an electronic map 2014A.

The input unit 2012 receives various types of information, such as numerical and textual information, and transfers signals, input in connection with the setting of various types of functions and the control of the functions of the terminal 2010, to the control unit 2011. Furthermore, the input unit 2012 may include at least one of a keypad and a touchpad that generates an input signal in response to the touch or manipulation of the user. In this case, the input unit 2012, together with the display unit 2013, may be configured in the form of a single touch panel (or a single touch screen), and may perform both input and display functions. Furthermore, the input unit 2012 may include not only input devices, such as a keyboard, a keypad, a mouse, and a joy stick, but also all types of input means that will be developed in the future. In particular, the input unit 2012 according to the present invention detects a signal adapted to display the electronic map, a signal adapted to execute a distance measurement function on the electronic map and a signal adapted to change a point in the distance measurement function, and then transfers the signals to the control unit 2011.

The display unit 2013 displays information about a series of operating states and operation results that are generated during the performance of the functions of the terminal 2010. Furthermore, the display unit 2013 may display the menu of the terminal 2010, user data input by the user, etc. In this case, the display unit 2013 may include a liquid crystal display (LCD), a thin film transistor LCD (TFT-LCD), organic light emitting diodes (OLEDs), light-emitting diodes (LEDs), organic light-emitting diodes (OLEDs), active matrix organic LEDs (AMOLEDs), a retina display, a flexible display, or a three-dimensional display. In this case, when the display unit 2013 is configured in the form of a touch screen, the display unit 2013 may perform some or all of the functions of the input unit 2012. In particular, display unit 2013 according to the present invention displays a screen in which the electronic map is displayed, a screen which provides a distance measurement function on the electronic map, etc.

The storage unit 2014 is a device configured to store data, includes a main storage device and an auxiliary storage device, and stores application programs required for the operation of the functions of the terminal 2010. The storage unit 2014 may basically include a program area and a data area. In this case, when each function is activated in response to a request from the user, the terminal 2010 executes a corresponding application programs under the control of the control unit 2011, and provides the function. In particular, the storage unit 2014 according to the present invention stores an OS adapted to boot up the terminal 2010, a program adapted to provide an electronic map via an application, etc. Furthermore, the storage unit 2014 stores an electronic map 2014A provided via an application.

The audio processing unit 2015 functions to transfer an audio signal, received from a speaker SPK adapted to play back and output the audio signal or a microphone MIC, to the control unit 2011. The audio processing unit 2015 may convert an analog audio signal, received via the microphone, into a digital form, and may transfer the digital signal to the control unit 2011. Furthermore, the audio processing unit 2015 may convert the digital audio signal, output from the control unit 2011, into an analog signal, and may output the analog signal via the speaker. In particular, the audio processing unit 2015 according to the present invention outputs an effect sound or execution sound attributable to the execution of an application.

The communication unit 2016 functions to transmit and receive data to and from the service device 2020 over the communication network 2030. In this case, the communication unit 2016 includes an RF transmission means configured to up convert and amplify the frequency of a transmitted signal and an RF reception means configured to low noise amplify and down convert the frequency of a received signal. The communication unit 2016 may include at least one of a wireless communication module (not shown) and a wired communication module (not shown). Furthermore, the wireless communication module is a configuration configured to transmit and receive data according to a wireless communication method. When the terminal 2010 uses wireless communication, the terminal 2010 may transmit and receive data to and from the service device 2020 using any one of a wireless network communication module, a wireless LAN communication module, and a wireless PAN communication module. Furthermore, the wired communication module is intended to transmit and receive data over a wired connection. The wired communication module may be connected to the communication network 2030 over a wired connection, and may transmit and receive data to and from the service device 2020. In particular, the communication unit 2016 according to the present invention communicates with the service device 2020, and transmits and receives information for the measurement of a distance on the electronic map.

The control unit 2011 may be a process device configured to run an OS (Operation System) and individual components. In particular, when a map application is executed, the control unit 2011 according to an embodiment of the present invention displays the electronic map via a map application. Furthermore, the control unit 2011 selects the distance measurement function on the electronic map.

The control unit 2011 detects input signals adapted to sequentially select a plurality of points in the distance measurement function, and determines the location information of the individual points. In this case, the control unit 2011 calculates measured information by applying the location information to the individual points. In this case, the control unit 2011 determines the measured information including distance information adapted to connect the individual selected points on the electronic map and information about the time required to move from a start point to a destination point using a transportation means, such as walking, a bicycle, a private car, or a public transportation means. Thereafter, the control unit 2011 displays the calculated measured information and the distance between the points on the electronic map.

Thereafter, when the location information of a specific one of a plurality of points for the distance measurement function is changed, the control unit 2011 determines the changed location information. Furthermore, the control unit 2011 modifies the generated measured information by incorporating the changed location information into the generated measured information, and provides the modified measured information. Furthermore, the control unit 2011 modifies and displays the measured information into which the changed location information has been incorporated and the distance between the points on the electronic map. In this case, the control unit 2011 detects a drag & drop touch signal input at a location at which one of a plurality of selected points is indicated on the electronic map, and determines the location information of a moved point in response to the detected touch signal. Thereafter, the control unit 2011 recalculates the measured information by incorporating the determined location information into the measured information.

Furthermore, the terminal 2010 according to another embodiment of the present invention provides information for the measurement of a distance on the electronic map while operating in conjunction with the service device 2020. First, when the map application is executed, the control unit 2011 of the terminal 2010 displays the electronic map via a map application. Furthermore, when input signals adapted to sequentially select a plurality of points for the distance measurement function are detected, the control unit 2011 determines the location information of the plurality of points and transmits the location information to the service device 2020.

When the measured information is received from the service device 2020, the control unit 2011 displays the measured information and the distance between the points on the electronic map. Thereafter, when an input signal adapted to change the location of a specific one of the plurality of points, the control unit 2011 transmits the input signal to the service device 2020.

When the measured information to which the changed location information has been applied is received from the service device 2020, the control unit 2011 modifies and displays the measured information and the distance between the points on the electronic map.

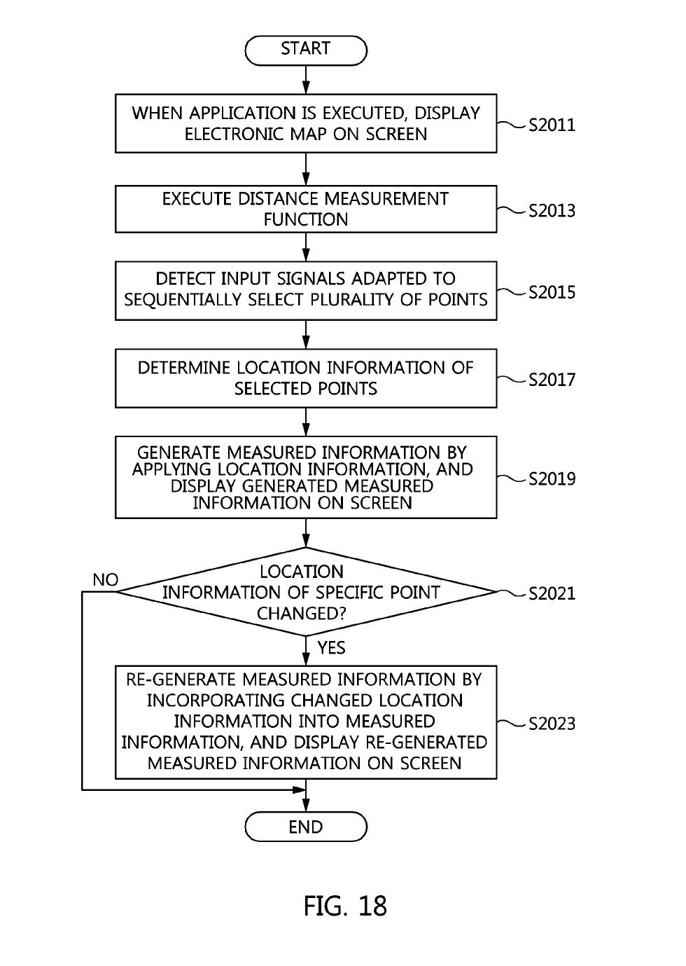

FIG. 17 is a block diagram showing the configuration of a service device according to the present invention.

Referring to FIG. 17, the service device 2020 according to the present invention includes a service control unit 2021, a service storage unit 2022, and a service communication unit 2023. In this case, the service control unit 2021 includes an electronic map provision module 2021A, a measured information generation module 2021B, and a modification module 2021C, and the service storage unit 2022 includes an electronic map 2022A, and measured information 2022B.

The service communication unit 2023 communicates with the terminal 2010 over the communication network 2030, and transmits and receives information for the measurement of a distance on the electronic map.

The service storage unit 2022 stores all programs related to the function execution of the service device 2020. In particular, the service storage unit 2022 according to the present invention stores a program adapted to provide the electronic map via an application, a program adapted to generate measured information in the distance measurement function on the electronic map, and a program adapted to modify the measured information in accordance with a change in the point in the distance measurement function. Furthermore, the service storage unit 2022 stores an electronic map 2022A provided via a map application, and information about a public transportation means available for the start and destination points of the plurality of points. Furthermore, the service storage unit 2022 stores measured information 2022B including distance information adapted to connect the individual selected points on the electronic map 2022A and information about the time required to move from a start point to a destination point using a transportation means, such as walking, a bicycle, a private car, or a public transportation means.

The service control unit 2021 may be a process device configured to run an OS (Operation System) and individual components. In particular, once information for the measurement of a distance provided via a map application and input onto the electronic map has been received from the terminal 2010, the service control unit 2021 according to the embodiment of the present invention determines the location information of the plurality of points based on the received information. Thereafter, the service control unit 2021 calculates measured information by applying the determined location information, and transmits the calculated measured information to the terminal 2010. In this case, the measured information includes distance information adapted to connect the individual selected points on the electronic map and information about the time required to move from a start point to a destination point using a transportation means, such as walking, a bicycle, a private car, or a public transportation means.

When an input signal adapted to change the location information of a specific one of the plurality of points displayed on the electronic map is received from the terminal 2010 after the measured information has been provided, the service control unit 2021 modifies the measured information by incorporating the changed location information into the measured information. Furthermore, the service control unit 2021 provides the modified measured information to the terminal 2010.

Furthermore, the service device 2020 configured as described above may be implemented as one or more servers that operate according to a server-based computing method or cloud method. In particular, the date for the measurement of a distance on the electronic map may be provided via a cloud computing function that may be permanently stored in a cloud computing device over the Internet. In this case, the cloud computing refers to a technology for serving Information Technology (IT) resources, for example, hardware (a server, a storage, a network, etc.), software (a database, security, a web server, etc.), service, data, virtualized using Internet technology, to digital terminals, such as desktops, tablet computers, notebooks, netbooks and smart phones, in an On demand manner.

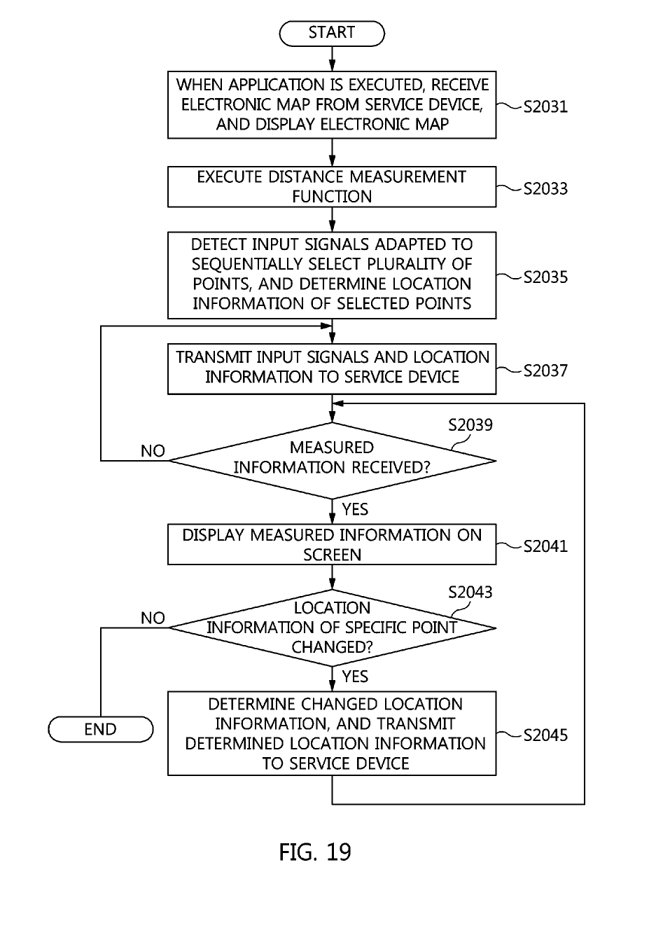

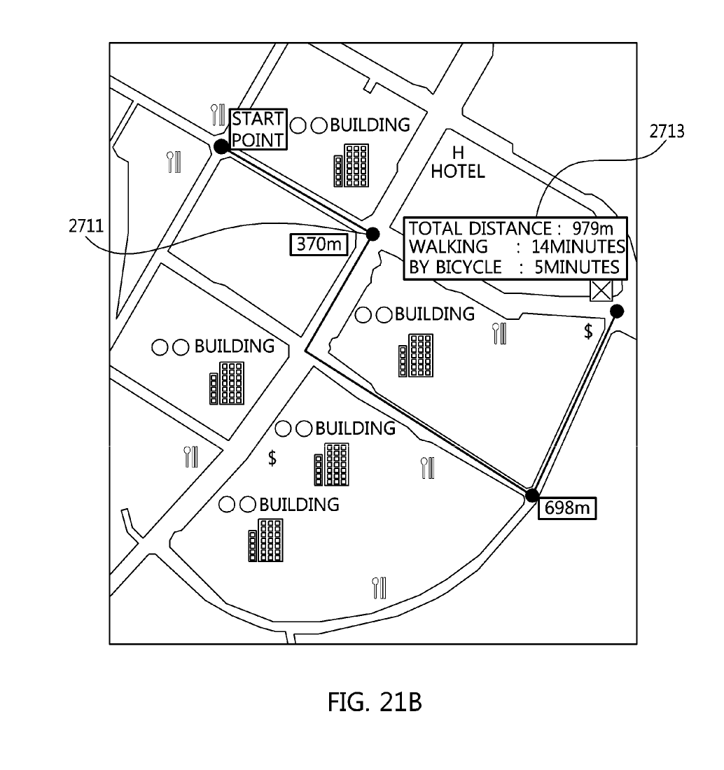

FIG. 18 is a flowchart illustrating a method of measuring a distance on an electronic map according to an embodiment of the present invention, and FIGS. 21A and 21B are exemplary diagrams illustrating the method of measuring a distance on an electronic map according to the embodiment of the present invention.

Referring to FIG. 18, when a map application is executed at step S2011, the terminal 2010 configured to provide the measurement of a distance on an electronic map according to the present invention displays an electronic map via a map application. Furthermore, the terminal 2010 selects a distance measurement function on the electronic map at step S2013.

The terminal 2010 detects input signals adapted to sequentially select a plurality of points in the distance measurement function and determines the location information of each of the points at steps S2015 to S2017. In this case, the terminal 2010 calculates measured information by applying the location information of each of the points. In this case, the terminal 2010 determines the measured information including distance information adapted to connect the individual selected points on the electronic map and information about the time required to move from a start point to a destination point using a transportation means, such as walking, a bicycle, a private car, or a public transportation means. Thereafter, the terminal 2010 displays the calculated measured information and the distance between the points on the electronic map at step S2019.

For example, as shown in FIG. 21a, the terminal 2010 detects a plurality of points 2701 to 2707 being selected on an image indicated on the electronic map via the distance measurement function. In this case, the terminal 2010 may detect input signals adapted to sequentially select a start point 2701, intermediate points 2703 and 2705 and a destination point 2707, and, once the selection of the points has been completed, may calculate each point-related measured information 2709 and may display the measured information 2709 on a screen. In this case, the measured information includes the distance and information about walking, a bicycle or the like as a transportation means.

The terminal 2010 determines whether the location information of a specific point has been changed while the measured information generated via the distance measurement function is being displayed at step S2021. That is, the terminal 2010 determines changed location information when the location information of the specific one of the plurality of points has been changed. Furthermore, the terminal 2010 modifies the measured information by incorporating the changed location information into the measured information and provides the modified measured information at step S2023. In this case, the terminal 2010 modifies and displays the measured information into which the changed location information has been incorporated and the distance between the points on the electronic map. In this case, the terminal 2010 detects a drag & drop touch signal input at a location at which a specific point is indicated, and determines the location information of a moved point based on the detected touch signal. Thereafter, terminal 2010 recalculates the measured information by applying the determined location information. For example, as shown in FIG. 21b, when the location of the intermediate point 2703 of the points 2701 to 2707 selected via the distance measurement function is moved to the changed intermediate point 2711 in response to a drag & drop touch signal, the terminal 2010 generates new measured information by applying the changed intermediate point 2711. Furthermore, the terminal 2010 automatically incorporates the newly generated measured information 2713 into a screen, and outputs the newly generated measured information 2713 onto the screen.

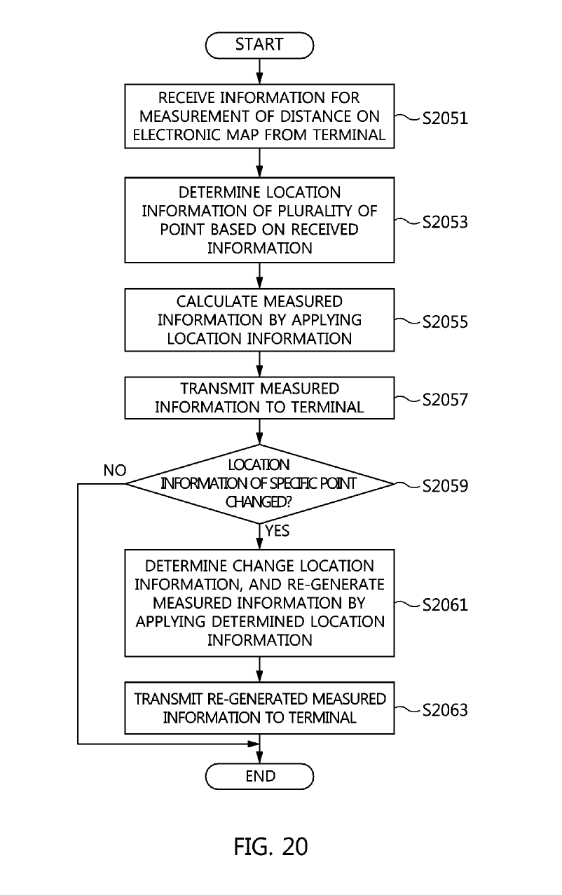

FIG. 19 is a flowchart illustrating a method of operating a terminal while operating in conjunction with a service device according to an embodiment of the present invention.

Referring to FIG. 19, when a map application is executed, the terminal 2010 configured to provide the process of measuring a distance on an electronic map while operating in conjunction with the service device 2020 according to the present invention displays an electronic map in the map application at step S2031. Furthermore, when input signals adapted to sequentially select a plurality of points are detected via a distance measurement function, the terminal 2010 determines the location information of the plurality of points and transmits the location information to the service device 2020 at steps S2033 to S2037.

The terminal 2010 determines whether the measured information has been received from the service device 2020 at step S2039. Once the measured information has been received from the service device 2020, the terminal 2010 displays the measured information and the distance between the points on the electronic map at step S2041. That is, the terminal 2010 determines the measured information including distance information adapted to connect the individual selected points on the electronic map and information about the time required to move from a start point to a destination point using a transportation means, such as walking, a bicycle, a private car, or a public transportation means.

Thereafter, the terminal 2010 determines the location information of a specific one of the plurality of points provided on the electronic map has been changed via a distance measurement function at step S2043. When an input signal adapted to change the location information of a specific one of the plurality of points is detected, the terminal 2010 transmits the input signal to the service device 2020. Furthermore, once the measured information into which the changed location information has been applied has been received from the service device 2020, the terminal 2010 modifies and displays the measured information and the distance between the points on the electronic map at step S2045.

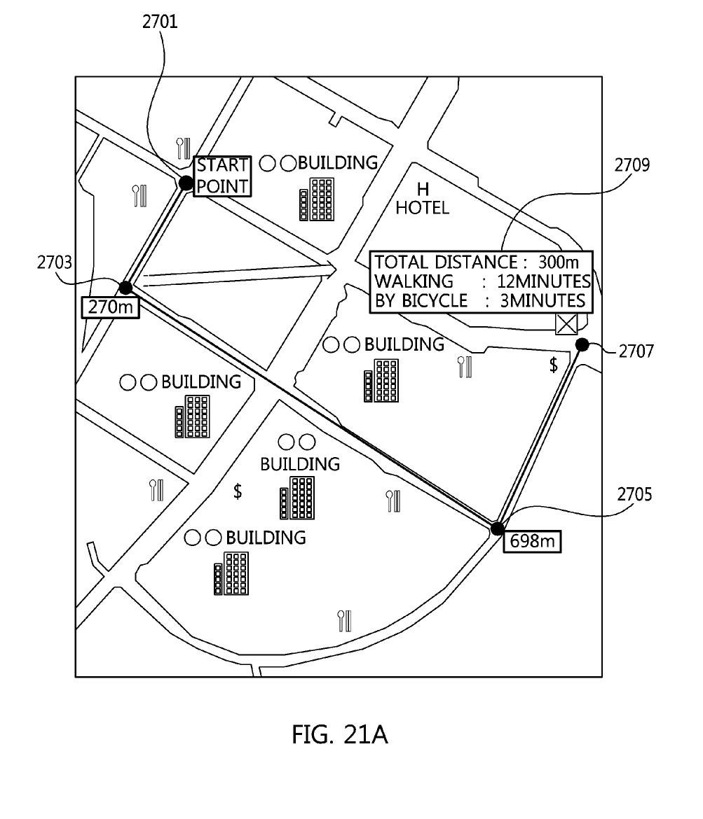

FIG. 20 is a flowchart illustrating a method of operating a service device while operating in conjunction with a terminal according to an embodiment of the present invention.

Referring to FIG. 20, once information for the measurement of a distance on the electronic map provided via a map application has been received from the terminal 2010, the service device 2020 configured to provide the process of measuring a distance on an electronic map while operating in conjunction with the terminal 2010 according to the present invention determines the location information of the plurality of points based on the received information at steps S2051 to S2053. Thereafter, the service device 2020 calculates measured information by applying the location information and transmits the measured information to the terminal 2010 at steps S2055 to S2057. In this case, the measured information includes distance information adapted to connect the individual selected points on the electronic map and information about the time required to move from a start point to a destination point using a transportation means, such as walking, a bicycle, a private car, or a public transportation means.

The service device 2020 determines whether the location information of a specific point has been changed from the terminal 2010 after providing the measured information to the terminal 2010 at step S2059. That is, once an input signal adapted to change the location of one of a plurality of points displayed on the electronic map has been received, the service device 2020 modifies the measured information by incorporating the changed location information into the measured information at step S2061. In this case, the service device 2020 receives the location information of a moved point in response to a drag & drop touch signal input from the terminal 2010 at a location where a specific point is indicated. Furthermore, the service device 2021 provides the modified measured information to the terminal 2010 at step S2063.

Meanwhile, memory installed in the terminal 2010 or service device 2020 stores information within the device. In an implementation, the memory is a computer-readable medium. The memory may be a volatile memory unit in an implementation, and may be a nonvolatile memory unit in another implementation. In an implementation, the storage device is a computer-readable medium. In various different implementations, the storage device may include, for example, a hard disk device, an optical disk device, or any other mass storage device.

Although the illustrative configuration of the apparatus has been shown in the present specification and the attached drawings, the functional operations and the implementations of the subject matter described in the present specification may be implemented in different types of digital electronic circuits, and may be implemented in the form of computer software, firmware, or hardware including the structures disclosed in the present specification and structural equivalents thereof or may be implemented by a combination of one or more thereof. The implementations of the subject matter described in the present specification may be implemented as one or more computer program products, i.e., one or more modules regarding computer program instructions encoded on a tangible storage medium in order to control the operations of the apparatus according to the present invention or perform execution based on the operations. The computer-readable medium may be a machine-readable storage device, a machine-readable storage board, a memory device, or a composition of substances influencing machine-readable radio wave-type signals, or a combination of one or more thereof.

Implementations or the various techniques described herein may be implemented in digital electronic circuitry, or in computer hardware, firmware, software, or in combinations thereof. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including complied or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The steps of the methods may be performed by one or more programmable processors executing a computer program to perform functions by operating on input data and generating output. The steps of the methods may be also performed by, and an apparatus may be implemented as, special purpose logic circuitry, e.g., a Field Programmable Gate Array (FPGA) or an Application-Specific Integrated Circuit (ASIC).

Processors suitable for the execution of a computer program include, by way of example, both general and special purpose microprocessors, and any one or more processors of any type of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, magnetic media such as a hard disk, a floppy disk and a magnetic tape, optical media such as compact disk read only memory (CD-ROM) and a digital video disk (DVD), magneto-optical media such as a floptical disk, and semiconductor memory such as read only memory (ROM), random access memory (RAM), flash memory, erasable programmable ROM (EPROM) and electrically erasable programmable ROM (EEPROM). The processor and the memory can be supplemented or incorporated by or into special purpose logic circuitry.

Although the present specification includes the details of a plurality of specific embodiments, the details should not be construed as limiting any invention or a scope that can be claimed, and on the contrary, the details should be construed as being descriptions of features that may be specific to the specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate lower-level combination. Furthermore, although features may operate in a specific combination and features may be initially depicted as being claimed, one or more features of a claimed combination may be excluded from the combination in some cases, and the claimed combination may be changed into a lower-level combination or a modification of the lower-level combination.

In the same manner, although operations are depicted in specific order in the drawings, it should not be understood that the operations must be performed in the depicted specific or sequential order or all the shown operations must be performed in order to obtain a preferred result. In a specific case, multi-tasking and parallel processing may be advantageous. Furthermore, it should not be understood that the separation of various system components of the aforementioned embodiments is required for all the embodiments. Rather, it should be understood that the aforementioned program components and systems may be integrated into a single software product or packaged into a multiple software product.

Meanwhile, the embodiments of the present invention disclosed in the present specification and the drawings are intended merely to present specific examples in order to help to understand the present invention, but are not intended to limit the scope of the present invention. It will be apparent to those skilled in the art that various modifications based on the technical spirit of the present invention, as well as the disclosed embodiments, can be made.

A space search service system according to an embodiment of the present invention is described below.

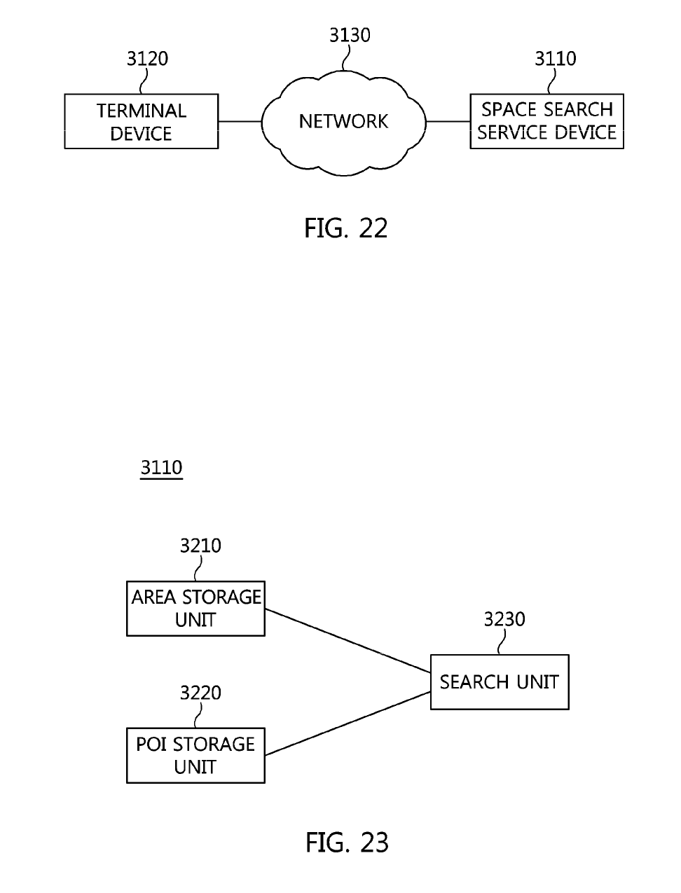

FIG. 22 is a block diagram showing the space search service system according to the embodiment of the present invention.

Referring to FIG. 22, the space search service system according to the embodiment of the present invention includes a space search service device 3110, a terminal device 3120, and a network 3130.

The space search service device 3110 stores area objects corresponding to areas within a map and a plurality of POI objects at least some of which matching the area objects, and, when there is an area object matching a POI object corresponding to the input of a user, makes a space search for the POI object and provides an extracted child POI object.

In this case, the POI object having the child POI object may be defined as a parent POI object in contrast with the child POI object.

In this case, the space search may be extracting a POI object, present within an area corresponding to an area object matching a POI object that is a target for the space search, as a child POI object.

In this case, when there is an area object matching the child POI object, the space search service device 3110 may make a space search for the child POI object, and may provide an extracted grandchild POI object.

In this case, the grandchild POI object is a term that is used on the basis of the parent POI object of the child POI object that is the target for the space search, and is a child POI object on the basis of the child POI object that is the target for the space search.

In this case, a POI object having the grandchild POI object may be defined as a grandparent POI object in the same manner as in the definition of the parent POI object.

In this case, the space search service device 3110 may provide a child POI object obtained by excluding a POI object corresponding to a grandchild POI object from extracted child POI objects.

In this case, when there is an area object that overlaps an area object, matching the POI object that is the target for the space search, at a preset or higher rate, the space search may further extract a POI object matching the overlapping area object as a child POI object.

In this case, the POI object corresponding to the input of the user may correspond to a building, and the child POI object may correspond to a floor of the building.

In this case, an area within the map corresponding to the area object may be a polygonal area.

The terminal device 3120 requests the provision of a POI object from the space search service device 3110, receives a POI object, an area object matching the POI object, and a child POI object of the POI object, and displays them so that the user can be notified of them.

In this case, although the terminal device 3120 according to the embodiment of the present invention may be a mobile communication terminal capable of connecting to a communication network and uploading or downloading data, the terminal device 3120 is not limited to the mobile communication terminal, but may be applied to various terminals, such as all information communication devices, multimedia terminals, wired terminals, fixed-type terminals, and Internet Protocol (IP) terminals. Furthermore, the terminal device 3120 may be advantageously used when it is one of mobile terminals having various mobile communication specifications, such as a handheld phone, a portable multimedia player (PMP), a mobile Internet device (MID), a smart phone, a desktop, a tablet PC, a notebook, a net book, an information communication device, etc.

In this case, the terminal device 3120 may display the received POI object and area object together. The terminal device 3120 may display the area corresponding to the area object on the map, and may provide the guidance of the space occupied by the POI to the user.

In this case, when the POI object is clicked, a space search for the POI object may be made.

In this case, when there is a child POI object, the terminal device 3120 may display the child POI object below the parent POI object in order to provide notification that there is the child POI object. In this case, when the child POI object is clicked, the terminal device 3120 displays the child POI object, and may also display a corresponding to area when there is the area object that matches the child POI object.

In this case, when the child POI object has a child POI object, i.e., when an initially received POI object has a grandchild POI object, a space search may be made in the same manner.

The network 3130 provides a path adapted to transfer information between the space search service device 3110 and the terminal device 3120, and is based on a concept including conventional networks and networks that will be developed in the future. For example, the network 3130 may include any one of or a combination of two or more of: wired/wireless short distance communication networks adapted to provide communication to various types of information devices within a limited area; a mobile communication network adapted to provide communication between mobile terminals and between a mobile terminal and the outside of the mobile terminal; a satellite communication network adapted to provide communication between earth stations using satellites; and wired/wireless communication networks. Meanwhile, the transmission method standard of the network 3130 is not limited to conventional transmission method standard, but may include all transmission method standards that will be developed in the future.

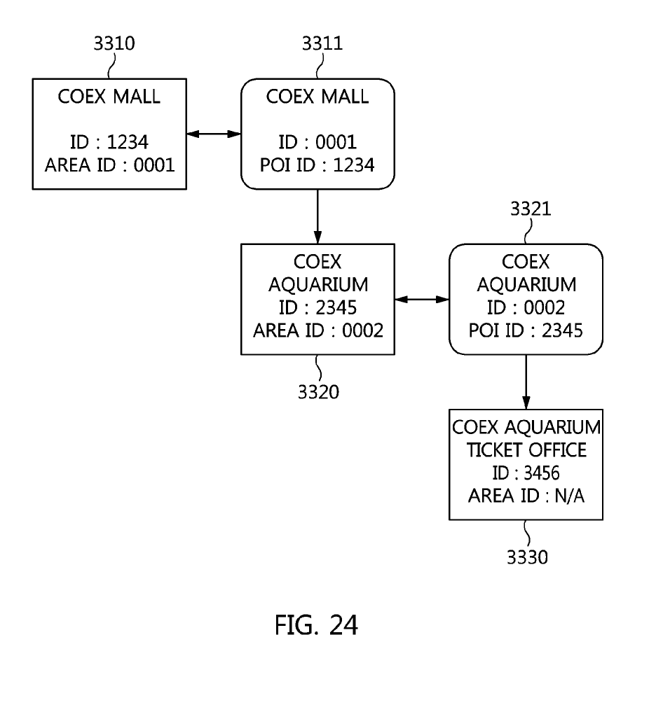

FIG. 23 is a block diagram showing an example of the space search service device shown in FIG. 22.

Referring to FIG. 23, the space search service device shown in FIG. 22 includes an area storage unit 3210, a POI storage unit 3220, and a search unit 3230.

The area storage unit 3210 stores area objects corresponding to areas within a map.

In this case, the area storage unit 3210 may include magnetic media such as a hard disk, a floppy disk and a magnetic tape, optical media such as compact disk read only memory (CD-ROM), magneto-optical media such as a floptical disk, and semiconductor memory such as read only memory (ROM), random access memory (RAM) and flash memory.

In an embodiment, the areas within the map corresponding to the area objects may be polygonal areas.

That is, area information may be stored by storing only the coordinates of points corresponding to the vertices of the polygonal areas.

The POI storage unit 3220 stores a plurality of POI objects, at least some of which match the area object.

In this case, the POI storage unit 3220 may include magnetic media such as a hard disk, a floppy disk and a magnetic tape, optical media such as compact disk read only memory (CD-ROM), magneto-optical media such as a floptical disk, and semiconductor memory such as read only memory (ROM), random access memory (RAM) and flash memory in the same manner as the area storage unit 3210.

In this case, by separately storing POI objects and area objects rather than adding area information to the POI objects, existing POI objects may be used without change and service may be provided with areas assigned to POIs.

In this case, the POI objects and the area objects may be matched to each other by storing the IDs of the area objects in the POI objects.

When a POI object has stored the ID of an area object, i.e., when there is a matching area object, the POI object is a POI object that can have a child POI object. In contrast, when a POI object has not stored the ID of an area object, i.e., when there is no matching area object, the POI object is a POI object that cannot have a child POI object.

When there is an area object matching a POI object corresponding to the input of the user, the search unit 3230 makes a space search for the POI object, and provides an extracted child POI object.

In this case, when there is an area object matching a POI object corresponding to the input of a user, the POI object corresponding to the input of the user is a POI object that can have a child POI object. However, when there is no area object matching a POI object corresponding to the input of a user, the POI object corresponding to the input of the user is a POI object that cannot have a child POI object, and thus it is necessary to make a space search.

In this case, a POI object having a child POI object may be defined as a parent POI object in contrast with the child POI object.

In an embodiment, the space search may be extracting a POI object, present within an area corresponding to an area object matching a POI object that is a target for the space search, as a child POI object.

That is, a POI object that belongs to an area corresponding to an area object matching a parent POI object becomes a child POI object.

In this case, it will be apparent that, when a child POI object is a POI object not matching an area object, the coordinates thereof must be located within an area corresponding to an area object matching a parent POI object.

However, when a POI object that is a target for determination is a POI object matching an area object, a determination method may be various.

For example, regardless of a matching area object, the coordinates of a POI object that is a target for determination are located within an area object matching the POI object that is the target for determination, the corresponding POI object may be determined to be a child POI.

Alternatively, only when an area corresponding to an area object matching a POI object that is a target for determination, i.e., a child POI object candidate, is all included in an area corresponding to an area object matching a POI object that is a target for a space search, i.e., a parent POI object candidate, the corresponding POI object may be determined to be a child POI.

Alternatively, only when a preset or larger proportion of an area corresponding to an area object matching a POI object that is a target for determination, i.e., a child POI object candidate, is included in an area corresponding to an area object matching a POI object that is a target for a space search, i.e., a parent POI object candidate, the corresponding POI object may be determined to be a child POI.

Since a hierarchical structure is not constructed by designating or inputting the information of a child POI object for or into a POI object or area object, it is sufficient if only the coordinate information of a POI object and the information of an area corresponding to an area object are input, and thus a separate task of constructing a hierarchical structure is not necessary. Furthermore, even when a POI object or area object is modified after a hierarchical structure has been constructed, the hierarchical structure is dynamically maintained without modification.

In an embodiment, when there is an area object matching the child POI object, the search unit 3230 may make a space search for the child POI object, and may provide an extracted grandchild POI object.

In this case, the grandchild POI object is a term that is used on the basis of the parent POI object of the child POI object that is the target for the space search, and is a child POI object on the basis of the child POI object that is the target for the space search.

In this case, a POI object having the grandchild POI object may be defined as a grandparent POI object in the same manner as in the definition of the parent POI object.

In this case, when there is an area object matching a grandchild POI object, a space search for the grandchild POI object is made and a child POI object of the grandchild POI object is extracted and provided, a 3 or higher-level hierarchical structure may be constructed.

In an embodiment, the search unit 3230 may provide a child POI object obtained by excluding a POI object corresponding to a grandchild POI object from extracted child POI objects.

For example, when POI object a has POI object b as a child POI object and POI object b has POI object c as a child POI object, POI object b and POI object c are extracted when a space search for POI object a is made. In this case, only POI object b excluding POI object c may be provided as the child POI object of POI object a. When POI object c is searched for, POI object b may be retrieved by making a space search for POI object a, and POI object c may be retrieved by making a space search for POI object b again.

That is, since inconvenience may occur when a grandchild POI object is also displayed, a limitation may be imposed such that only a POI object one level below a corresponding object, excluding a grandchild POI object, can be retrieved for via a space search.

In an embodiment, a POI object corresponding to the input of the user corresponds to a building, and the child POI object may correspond to one floor of the building.

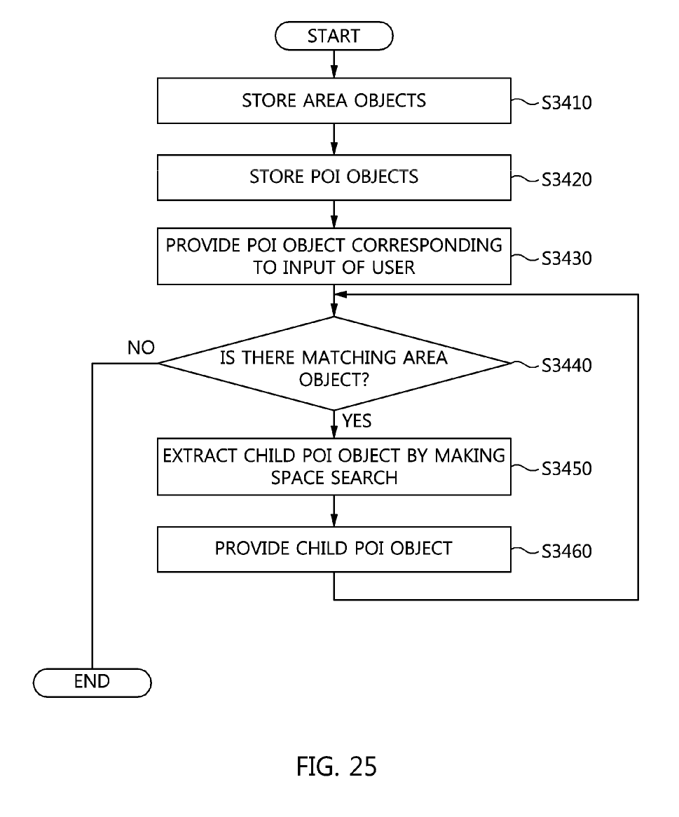

FIG. 24 is a diagram showing an example of a hierarchical structure of POI objects and area objects according to an embodiment of the present invention.

Referring to FIG. 24, the hierarchical structure of POI objects and area objects according to the embodiment of the present invention includes POI objects 3310, 3320 and 3330 and area objects 3311 and 3321.

Each of the POI objects 3310, 3320 and 3330 includes the name and ID of the POI object. Furthermore, at least part of the POI objects 3310 and 3320 includes the ID of an area object matching the POI object. Although not shown in FIG. 24, each includes coordinate information. Furthermore, the POI objects 3310, 3320 and 3330 are shown in the form of rectangles having right angles in FIG. 24.

Each of the area objects 3311 and 3312 includes the name and ID of an area object and the ID of a matching POI object. As not shown in FIG. 24, each of the area objects 3311 and 3312 includes the area information of a corresponding area within the map. Furthermore, the area objects 3311 and 3312 are shown in the form of rectangles having round corners in FIG. 24.

In an embodiment, areas within the map corresponding to the area objects 3311 and 3312 may be polygonal areas.

That is, the area information may be stored by storing only the coordinates of points corresponding to the vertices of a polygonal area.

In this case, by separately storing the POI objects 3310, 3320 and 3330 and the area objects 3311 and 3321 rather than adding area information to the POI object 3310 and 3320, existing POI objects may be used without change and service may be provided with areas assigned to POIs.

When a POI object has stored the ID of an area object, i.e., when there is a matching area object, the POI object is a POI object that can have a child POI object. That is, the POI objects 3310 and 3320 for which there are matching area objects can have child POI objects.

In contrast, when a POI object has not stored the ID of an area object, i.e., when there is no matching area object, the POI object is a POI object that cannot have a child POI object. That is, the POI object 3330 for which there is no matching area object cannot have a child POI object.

In this case, a POI object having a child POI object may be defined as a parent POI object in contrast with the child POI object.

When there is an area object matching a POI object corresponding to the input of the user, the space search service device makes a space search for the POI object, and provides an extracted child POI object.

In this case, when there is an area object matching a POI object corresponding to the input of a user, the POI object corresponding to the input of the user is a POI object that can have a child POI object. However, when there is no area object matching a POI object corresponding to the input of a user, the POI object corresponding to the input of the user is a POI object that cannot have a child POI object, and thus it is necessary to make a space search.

In an embodiment, the space search may be extracting a POI object, present within an area corresponding to an area object matching a POI object that is a target for the space search, as a child POI object.

That is, a POI object that belongs to an area corresponding to an area object matching a parent POI object becomes a child POI object.

In this case, it will be apparent that, when a child POI object is a POI object not matching an area object, the coordinates thereof must be located within an area corresponding to an area object matching a parent POI object.

However, when a POI object that is a target for determination is a POI object matching an area object, a determination method may be various.

For example, regardless of a matching area object, the coordinates of a POI object that is a target for determination are located within an area object matching the POI object that is the target for determination, the corresponding POI object may be determined to be a child POI.

Alternatively, only when an area corresponding to an area object matching a POI object that is a target for determination, i.e., a child POI object candidate, is all included in an area corresponding to an area object matching a POI object that is a target for a space search, i.e., a parent POI object candidate, the corresponding POI object may be determined to be a child POI.

Alternatively, only when a preset or larger proportion of an area corresponding to an area object matching a POI object that is a target for determination, i.e., a child POI object candidate, is included in an area corresponding to an area object matching a POI object that is a target for a space search, i.e., a parent POI object candidate, the corresponding POI object may be determined to be a child POI.

For example, there are a POI object 3310 corresponding to overall COEX Mall and an area object 3311 corresponding to the area of COEX Mall. Since a POI object 3320 corresponding to COEX Aquarium present within COEX Mall is located within the area of COEX Mall, the POI object 3320 is extracted as the child POI of the COEX Mall POI object 3310 by a space search. Although there is an area object 3321 matching the COEX Aquarium POI object 3320, the coordinates of the COEX Aquarium POI object 3320 and an area corresponding to the area object 3321 are all located within the area object 3311 matching the COEX Mall POI object 3310, and thus the COEX Aquarium POI object 3320 cannot be extracted as a child POI object by any of the above-described methods.

In an embodiment, when there is an area object matching the child POI object, the space search service device may make a space search for the child POI object, and may provide an extracted grandchild POI object.

In this case, the grandchild POI object is a term that is used on the basis of the parent POI object of the child POI object that is the target for the space search, and is a child POI object on the basis of the child POI object that is the target for the space search.

In this case, a POI object having the grandchild POI object may be defined as a grandparent POI object in the same manner as in the definition of the parent POI object.

For example, there are a child POI object 3320 of the COEX Mall POI object 3310 and a matching area object 3321. In this case, the child POI object 3320 is a POI object that can have a child POI object, and a space search for the child POI object 3320 may be made. A COEX Aquarium ticket office POI object 3330 located within the area object 3321 corresponding to COEX Aquarium is extracted as the child POI object of the COEX Aquarium POI object 3320. In this case, the COEX Aquarium ticket office POI object 3330 corresponds to a grandchild POI object on the basis of the COEX Mall POI object 3310, and the COEX Mall POI object 3310 corresponds to a grandparent POI object on the basis of the COEX Aquarium ticket office POI object 3330.

Since the grandchild POI object 3330 has no matching area object, a space search is not made.

Although not shown in FIG. 24, when there is an area object matching the grandchild POI object 3330, a space search for the grandchild POI object 3330 is made, and a child POI object of the grandchild POI object 3330 is extracted and provided, a 3 or higher-level hierarchical structure may be constructed.

In an embodiment, the space search service device may provide a child POI object obtained by excluding a POI object corresponding to a grandchild POI object from extracted child POI objects.

For example, when a space search for the COEX Mall POI object 3310 is made, the COEX Aquarium POI object 3320 and the COEX Aquarium ticket office POI object 3330 located within an area corresponding to the matching area object 3311 may be all extracted as child POIs, but on the COEX Aquarium POI object 3320 excluding the COEX Aquarium ticket office POI object 3330 corresponding to the child POI object of the COEX Aquarium POI object 3320, i.e., the grandchild POI object of the COEX Mall POI object 3310, may be provided as the child POI object of the COEX Mall POI object 3310. When the COEX Aquarium ticket office POI object 3330 is searched for, the COEX Aquarium POI object 3320 may be retrieved by making a space search for the COEX Mall POI object 3310, and the COEX Aquarium ticket office POI object 3330 may be retrieved by making a space search for the COEX Aquarium POI object 3320 again.

That is, since inconvenience may occur when a grandchild POI object is also displayed, a limitation may be imposed such that only a POI object one level below a corresponding object, excluding a grandchild POI object, can be retrieved for via a space search.

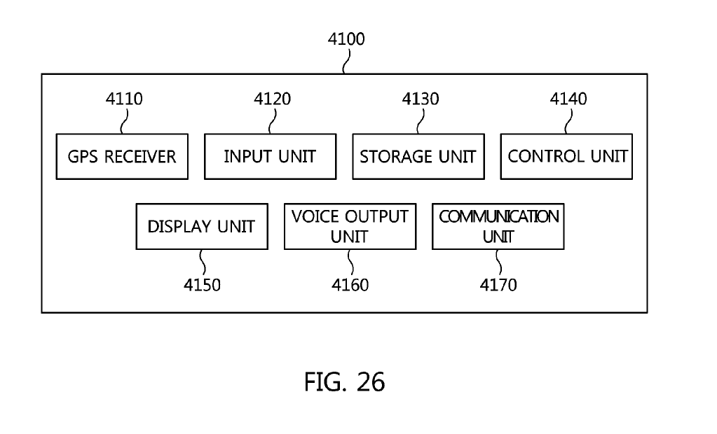

FIG. 25 is an operation flowchart showing an example of a space search service method according to an embodiment of the present invention.

Referring to FIG. 25, in the space search service method according to the embodiment of the present invention, area objects corresponding to areas within a map are stored at step S3410.

In an embodiment, the areas within the map corresponding to the area objects may be polygonal areas.

That is, area information may be stored by storing only the coordinates of points corresponding to the vertices of the polygonal areas.

Furthermore, in the space search service method according to the embodiment of the present invention, a plurality of POI objects, at least some of which match the area objects, is stored at step S3420.

In this case, by separately storing POI objects and area objects rather than adding area information to the POI objects, existing POI objects may be used without change and service may be provided with areas assigned to POIs.

In this case, the POI objects and the area objects may be matched to each other by storing the IDs of the area objects in the POI objects.

When a POI object has stored the ID of an area object, i.e., when there is a matching area object, the POI object is a POI object that can have a child POI object. In contrast, when a POI object has not stored the ID of an area object, i.e., when there is no matching area object, the POI object is a POI object that cannot have a child POI object.

Furthermore, in the space search service method according to the embodiment of the present invention, a POI object corresponding to the input of a user is provided at step S3430.

Furthermore, in the space search service method according to the embodiment of the present invention, it is determined where there is an area object matching a POI object that is a target for a space search at step S3440.

In this case, a POI object that is a target for an initial space search may be a POI object corresponding to the input of the user.

Furthermore, in the space search service method according to the embodiment of the present invention, when there is no matching area object, the corresponding POI object is a POI object that cannot have a child POI object, and thus a space search therefor is not made.

Furthermore, in the space search service method according to the embodiment of the present invention, when there is a matching area object, a space search is made and a child POI object is extracted at step S3450.

In this case, a POI object having a child POI object may be defined as a parent POI object in contrast with the child POI object.

In an embodiment, the space search may be extracting a POI object, present within an area corresponding to an area object matching a POI object that is a target for the space search, as a child POI object.

That is, a POI object that belongs to an area corresponding to an area object matching a parent POI object becomes a child POI object.

In an embodiment, a POI object corresponding to the input of the user corresponds to a building, and the child POI object may correspond to one floor of the building.

In this case, it will be apparent that, when a child POI object is a POI object not matching an area object, the coordinates thereof must be located within an area corresponding to an area object matching a parent POI object.

However, when a POI object that is a target for determination is a POI object matching an area object, a determination method may be various.

For example, regardless of a matching area object, the coordinates of a POI object that is a target for determination are located within an area object matching the POI object that is the target for determination, the corresponding POI object may be determined to be a child POI.

Alternatively, only when an area corresponding to an area object matching a POI object that is a target for determination, i.e., a child POI object candidate, is all included in an area corresponding to an area object matching a POI object that is a target for a space search, i.e., a parent POI object candidate, the corresponding POI object may be determined to be a child POI.

Alternatively, only when a preset or larger proportion of an area corresponding to an area object matching a POI object that is a target for determination, i.e., a child POI object candidate, is included in an area corresponding to an area object matching a POI object that is a target for a space search, i.e., a parent POI object candidate, the corresponding POI object may be determined to be a child POI.

Since a hierarchical structure is not constructed by designating or inputting the information of a child POI object for or into a POI object or area object, it is sufficient if only the coordinate information of a POI object and the information of an area corresponding to an area object are input, and thus a separate task of constructing a hierarchical structure is not necessary. Furthermore, even when a POI object or area object is modified after a hierarchical structure has been constructed, the hierarchical structure is dynamically maintained without modification.

Furthermore, in the space search service method according to the embodiment of the present invention, the child POI object is provided at step S3460.

Furthermore, in the space search service method according to the embodiment of the present invention, it is determined whether there is a matching area object for the extracted child POI object at step S3440, and, if there is a matching area object, a child POI object is extracted by making a space search again at step S3450. Furthermore, the extracted child POI object is provided at step S3460.

In this case, since the extracted child POI object is the child POI object of the child POI object, the extracted child POI object becomes a grandchild POI object on the basis of the POI object corresponding to the input of the user.

In this case, a POI object having the grandchild POI object may be defined as a grandparent POI object in the same manner as in the definition of the parent POI object.

In this case, step S3440 of determining whether there is an area object, step S3450 of extracting a child POI object by making a space search, and step S3460 of providing the child POI object may be repeated until there is no child POI object extracted in response to a request from the user or there is no matching area object.

Accordingly, a 3 or higher-level hierarchical structure may be constructed.

In an embodiment, a child POI object obtained by excluding a POI object corresponding to a grandchild POI object from extracted child POI objects may be provided.

For example, when POI object a has POI object b as a child POI object and POI object b has POI object c as a child POI object, POI object b and POI object c are extracted when a space search for POI object a is made. In this case, only POI object b excluding POI object c may be provided as the child POI object of POI object a. When POI object c is searched for, POI object b may be retrieved by making a space search for POI object a, and POI object c may be retrieved by making a space search for POI object b again.

That is, since inconvenience may occur when a grandchild POI object is also displayed, a limitation may be imposed such that only a POI object one level below a corresponding object, excluding a grandchild POI object, can be retrieved for via a space search.

The steps shown in FIG. 25 may be performed in the sequence shown in FIG. 25, in a sequence reverse to the former sequence, or concurrently.

The space search service method according to the present invention may be implemented as a program or a smart phone app that can be executed by various computer means. In this case, the program or smart phone app may be recorded on a computer-readable storage medium. The computer-readable storage medium may include program instructions, data files, and data structures solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. These hardware devices may be configured to operate as one or more software modules in order to perform the operation of the present invention, and the vice versa.

The above-described space search service method and the device therefor according to the present invention are not limited to the configurations and methods of the above-described embodiments, but some or all of the embodiments may be configured to be selectively combined such that the embodiments can be modified in various manners.

A navigation device and method according to an embodiment of the present invention are described below.

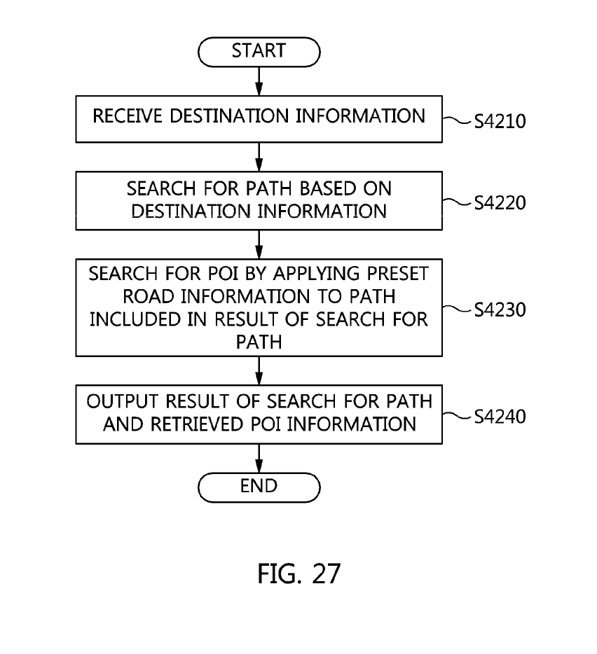

FIG. 26 is a block diagram showing the configuration of the navigation device 4100 according to the embodiment of the present invention.

As shown in FIG. 26, the navigation device 4100 includes a GPS receiver 4110, an input unit 4120, a storage unit 4130, a control unit 4140, a display unit 4150, a voice output unit 4160, and a communication unit 4170. All the components of the navigation device 4100 shown in FIG. 26 are not essential components. The navigation device 4100 may be implemented using a number of components larger than the number of shown components, or may be implemented using a number of components smaller than the number of shown components.

The control unit 4140 searches for a path based on destination information. Thereafter, the control unit 4140 searches for a POI by incorporating preset road information (or road attribute information) into a path included in the result of the search for a path. Thereafter, the control unit 4140 outputs the result of the search for a path and the corresponding retrieved POI, into which the preset road information (or road attribute information) has been incorporated, via the display unit 4150 and the voice output unit 4160.

The GPS receiver 4110 receives GPS signals transmitted from satellites, and generates the location data of the navigation device 4100 based on longitude and latitude coordinates included in the received GPS signals in real time. In this case, the generated location data is defined as the current location (or current location data) of the navigation device 4100. In this case, the location information may be received via Wi-Fi or Wibro communication as well as the GPS receiver 4110. Furthermore, although location-based technology chiefly uses GPS information, i.e., signals received by the GPS receiver 4110, the location-based technology may use a hybrid positioning system using both cell tower signal triangulation and Wi-Fi positioning information in addition to the GPS information.

Furthermore, the signals received via the GPS receiver 4110 may be configured to provide the location information of the terminal to the navigation device 4100 using wireless communication methods, including 4802.11, i.e., a wireless network standard for wireless LANs including a wireless LAN and some infrared communication provided by the Institute of Electrical and Electronics Engineers (IEEE); 4802.15, i.e., a standard for wireless Personal Area Networks (PANs) including Bluetooth, UWB, ZigBee, etc.; 4802.16, i.e., a standard for Metropolitan Area Networks (MANs) including Fixed Wireless Access (FWA) and Broadband Wireless Access (BWA); and 4802.20, i.e., a mobile Internet standard for Mobile Broadband Wireless Access (MBWA) including Wibro, WiMAX, etc.

Furthermore, when the corresponding navigation device 4100 is provided in a vehicle, the navigation device 4100 may further include a Dead-Reckoning (DR) sensor that measures the travelling direction of the corresponding vehicle (or navigation device 4100) and the speed of the vehicle and generates second location data based on the measured travelling direction and speed of the vehicle.

As described above, when the navigation device 4100 further includes the DR sensor, the GPS receiver 4110 may configure a data collection unit (not shown) along with the DR sensor.

Furthermore, since technology for generating the predicted location of the navigation device 4100 (or vehicle) based on the location data generated by the GPS receiver 4110 and the second location data generated by the DR sensor is well-known technology, a detailed description thereof is omitted.

The input unit 4120 receives a signal attributable to the manipulation of a button or the selection of a function by a user, and receives a command or control signal generated by the touch or scroll of a displayed screen.

Furthermore, the input unit 4120 receives a signal corresponding to information input by the user, and may use various devices, such as a keypad, a dome switch, a (resistive/capacitive) touch pad, a touch screen, a jog wheel, a jog switch, a jog shuttle, a mouse, a stylus pen, a touch pen, etc.

Furthermore, the input unit 4120 receives destination information based on the input of the user via a key pad or touch screen. In this case, the destination information may be any one of a destination, and a point of departure and a destination.

The storage unit 4130 stores data and a program required for the operation of the navigation device 4100.

Furthermore, the storage unit 4130 stores map data. In this case, the map data that is stored includes geographic coordinates or longitude and latitude coordinates that indicate a latitude and a longitude in Degree/Minute/Second (DMS) units. In this case, the map data that is stored may use Universal Transverse Mercator (UTM) coordinates, Universal Polar System (UPS) coordinates, Transverse Mercator (TM) coordinates, etc., as well as geographic coordinates. In this case, the map data that is stored in the storage unit 4130 may be map data transmitted from a server.

Furthermore, the storage unit 4130 stores various types of information, such as various types of menu screens, POIs (Point Of Interests; hereinafter referred to as “POIs”), function characteristic information based on specific locations of map data, etc.

Furthermore, the storage unit 4130 stores various User Interfaces (UIs), Graphic User Interfaces (GUIs), etc.

Furthermore, the storage unit 4130 stores data and programs required for the operation of the navigation device 4100.

Furthermore, the storage unit 4130 stores destination information received via the input unit 4120. In this case, the destination information may be any one of a destination, and a point of departure and a destination.

Furthermore, the storage unit 4130 receives per road-based various types of state information (Transport Protocol Expert Group (TPEG) information including information, such as traffic information, accident information, etc.) from a server (for example, an information provision server or a call center), connected via the communication unit 4170, at periodic/non-periodic time intervals, and stores the received per road-based various types of state information.

Furthermore, the storage unit 4130 stores various types of information (including content, control signals, etc.) received via the communication unit 4170.

Furthermore, the storage unit 4130 stores previously set per road-based road information (or road attribute information) under the control of the control unit 4140. In this case, the road information includes road types (or usage types) (including, for example, a general road, an overpass, an underground road, a national road, an arterial road, a vehicle-dedicated road, an expressway, etc.), road scales (including, for example, a broad road, a wide road, a middle road, a narrow road, etc.), road functions (including, for example, a main arterial road, a minor arterial road, a collector road, a local load, a special road, etc.), lane information (including, for example, 1 lane, 2 lanes, . . . , N lanes, etc.), facility information (including, for example, a service area, an interchange, an intersection, a junction, a tunnel, a bridge, etc.), road speed information (including, for example, average speed information, lower limit speed information, upper limit speed information, etc.), etc.

The control unit 4140 functions to perform the overall control of the navigation device 4100.

Furthermore, the control unit 4140 generates the current estimated location of the navigation device 4100 (or the vehicle in which the corresponding navigation device 4100 is provided) based on location data generated via the GPS receiver 4110 (or location data generated via the corresponding GPS receiver 4110 and second location data generated via the DR sensor).

Furthermore, the control unit 4140 reads map data corresponding to a traveling path previously stored in the storage unit 4130.

Furthermore, the control unit 4140 acquires matching map information (or a map matching result) by matching the generated estimated location against a link (a road) included in the read map data. for example, the control unit 4140 generates the estimated location of the navigation device 4100 (or the vehicle in which the navigation device 4100 is provided) based on the estimated location, matches the generated estimated location against links within the map data, stored in the storage unit 4130, in link sequence, and acquires matching map information (a map matching result). In this case, the matching map information (the map matching result) is information that is generated by referring to preset user information, a road state using TPEG information or the like, and the state information of the current vehicle (including an oil state, a tire air pressure state and the like). In this case, the TPEG information is information transmitted from an external information provision center (or server) (not shown) or call center (not shown) connected via the communication unit 4170.

Furthermore, the control unit 4140 generates road guide information based on the matching map information. In this case, the generated road guide information includes image information and a control signal. In this case, the image information includes at least one or more of map data, POI information, road (or sidewalk) information, lane information, speed limit information, and turn-by-turn list information. Furthermore, the control signal includes a signal adapted to control voice information (including, for example, safe driving helper data, voice guide information, etc.) related to the image information. In this case, safe driving helper data (or safe driving information) includes information required for safe driving, such as the traveling speed and direction of a vehicle or the like (for example “00 kilometers-per-hour area. Drive safely”), a sharp curve area (for example “Sharp curve area. Drive safely”), a real-time traffic accident occurrence area, an accident black spot (for example, “Accident black spot. Drive safely”), a speeding dangerous area (for example, “Speeding dangerous area. Drive safely”), a fog area (for example, “Fog area. Drive safely”), etc.

Furthermore, the control unit 4140 outputs the generated road guide information via at least one of the display unit 4150 and the voice output unit 4160.

Furthermore, the control unit 4140 receives real-time traffic information from the information provision center connected via the communication unit 4170. The corresponding real-time traffic information may be used for the generation of the road guide information.

Furthermore, the control unit 4140 stores destination information, received or determined via any one of the input unit 4120, the display unit 4150 and the communication unit 4170, in the storage unit 4130.

In this case, the corresponding destination information may be acquired using any one of the following methods.

First, the display unit 4150 receives destination information based on the touch or input of a user via a user input screen (or a touch screen) displayed on the corresponding display unit 4150. Furthermore, the display unit 4150 provides the received destination information to the control unit 4140. In this case, the destination information may be information about any one of a destination, and a point of departure and a destination.

Second, the control unit 4140 may receive destination information based on the input of the user via the input unit 4120. In this case, the control unit 4140 may receive a voice message (including destination information) of the user via the input unit 4120, and may extract (or determine) destination information included in the received voice message by performing voice recognition (or preset signal processing) on the received voice message and then performing natural language processing the voice recognized voice data.

Third, the control unit 4140 may receive a signal including destination information, transmitted from another terminal, via the communication unit 4170.

Furthermore, the control unit 4140 searches for a path based on the received destination information. In this case, the control unit 4140 may perform a path search function using TPEG information including information, such as current traffic status, etc., transmitted from a server (not shown).

Furthermore, the control unit 4140 searches for a POI by incorporating preset road information (or road attribute information) into a path included in the result of the search for a path. In this case, the road information includes road types (or usage types) (including, for example, a general road, an overpass, an underground road, a national road, an arterial road, a vehicle-dedicated road, an expressway, etc.), road scales (including, for example, a broad road, a wide road, a middle road, a narrow road, etc.), road functions (including, for example, a main arterial road, a minor arterial road, a collector road, a local load, a special road, etc.), lane information (including, for example, 1 lane, 2 lanes, . . . , N lanes, etc.), facility information (including, for example, a service area, an interchange, an intersection, a junction, a tunnel, a bridge, etc.), road speed information (including, for example, average speed information, lower limit speed information, upper limit speed information, etc.), etc.

That is, the control unit 4140 searches for a POI located around the corresponding path by incorporating the preset road information into the path included in the result of the search for a path.

Although the path search function and the POI search function have been separately described in the embodiment of the present invention, the present invention is not limited thereto. A POI may be also searched for by applying road information along a path upon a search for a path.

As described above, upon a search for a path, the control unit 4140 may make a search for a path and a search for a POI by applying preset road information as well as destination information.

Furthermore, the control unit 4140 generates path search road guide information based on the result of the search for a path. In this case, the generated path search road guide information includes image information and a control signal covering the range from a point of departure to a destination. In this case, the image information covering the range from a point of departure to a destination includes at least one or more of map data, POI information, road (or sidewalk) information, lane information, speed limit information, and turn-by-turn list information. Furthermore, the road information along the path is incorporated into the image information covering the range from a point of departure to a destination, and the image information covering the range from a point of departure to a destination includes POI information corresponding to the road information along the path.

Furthermore, the control unit 4140 outputs the generated path search road guide information (including, for example, the result of the performed search for a path and the retrieved POI) via the display unit 4150 and the voice output unit 4160.

Furthermore, when the current location of the navigation device 4100 is located adjacent to a corresponding POI corresponding to the preset road information (or the current location of the navigation device 4100 is located within a preset distance from the corresponding POI), the control unit 4140 may output information about the corresponding POI via the display unit 4150 and the voice output unit 4160. That is, the display unit 4150 may flicker information about the corresponding POI under the control of the control unit 4140, or the voice output unit 4160 outputs voice information, for example, “There is a □□ POI within ∘∘ meters,” under the control of the control unit 4140.

Furthermore, when the POI information corresponding to the corresponding road information displayed on the display unit 4150 is selected, the control unit 4140 performs control so that the detailed information of the corresponding POI information is displayed on the display unit 4150.

Furthermore, when the corresponding POI information is selected from the detailed information of the corresponding POI information, displayed on the display unit 4150, as an stop (or when the corresponding POI information displayed on the display unit 4150 is selected), the control unit 4140 may make a search for a path passing through the corresponding POI information, i.e., a stop selected from a path to a final destination, again, and may output the result of the performed search for a path via the display unit 4150 and the voice output unit 4160.

The display unit 4150 may display content, such as a menu screen, etc., using a user interface and a graphic user interface, stored in the storage unit 4130, under the control of the control unit 4140. In this case, the content displayed on the display unit 4150 includes a menu screen including not only text or image data (including various types of information data) but also data, such as an icon, a list menu, a combo box, and the like. Furthermore, the display unit 4150 may be a touch screen.

Furthermore, the display unit 4150 displays image information included in the road guide information generated under the control of the control unit 4140. In this case, the image information includes at least one or more of map data, POI information, road (or sidewalk) information, lane information, speed limit information, and turn-by-turn list information.

Furthermore, the display unit 4150 displays the result of the search for a path and a retrieved POI under the control of the control unit 4140.

Furthermore, when a path corresponding to the destination information is displayed, the display unit 4150 also displays POI information corresponding to the preset road information (or road attribute information) under the control of the control unit 4140. In this case, the POI information displayed on the display unit 4150 may be displayed differently from surrounding general POI information (or the POI information of a land mark function that does not correspond to the corresponding road information) (for example, in terms of color, size, font, emoticon, icon, or the like).

That is, the control unit 4140 controls the display unit 4150 so that general building POI information located on the path to the destination is displayed in gray, and controls the display unit 4150 so that one or more pieces of POI information (including, for example, a service area located on an expressway, etc.) corresponding to adjacent one or more pieces of road information along the path to the destination are displayed in blue.

The voice output unit 4160 outputs voice information included in a signal on which a predetermined signal processing has been performed by the control unit 4140. In this case, the voice output unit 4160 may be a speaker.

Furthermore, the voice output unit 4160 outputs voice information included in the road guide information and the result of the search for a path (or the path search road guide information) generated by the control unit 4140.

The communication unit 4170 communicates with an internal component or at least one external terminal over a wired/wireless communication network. In this case, the external terminal may include an information provision server, a call center, etc.

Furthermore, the communication unit 4170 receives TPEG information or transmits generated road guide information to at least one other connected terminal under the control of the control unit 4140.

As described above, upon a search for a path, the search for a path may be made by applying road information (or road attribute information) along a path.

A navigation method according to the present invention is described in detail below with reference to FIGS. 26 to 29.

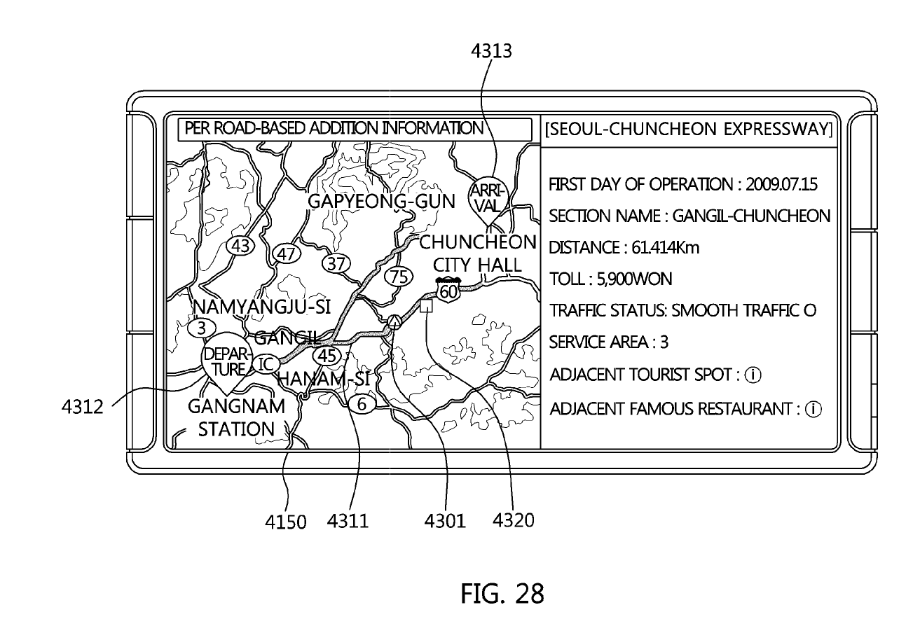

FIG. 27 is a flowchart showing the navigation method according to the embodiment of the present invention.

First, the control unit 4140 receives or determines destination information.

That is, the display unit 4150 receives destination information based on the touch or input of a user via a user input screen (or a touch screen) displayed on the corresponding display unit 4150. Furthermore, the display unit 4150 provides the received destination information to the control unit 4140. In this case, the destination information may be information about any one of a destination, and a point of departure and a destination.

Alternatively, the control unit 4140 may receive destination information based on the input of the user via the input unit 4120. In this case, the control unit 4140 may receive a voice message (including destination information) of the user via the input unit 4120, and may extract (or determine) destination information included in the received voice message by performing voice recognition (or preset signal processing) on the received voice message and then performing natural language processing the voice recognized voice data.

Alternatively, the control unit 4140 may receive a signal including destination information, transmitted from another terminal, via the communication unit 4170.

As described above, the control unit 4140 may receive the destination information using various methods.

As an example, the control unit 4140 determines (or receives) destination information (for example, the fact that the destination is □□ Playground) based on the input of the user via a user input screen displayed on display unit 4150 at step S4210.

Thereafter, the control unit 4140 searches for a path based on the received destination information. In this case, the control unit 4140 may perform a path search function using TPEG information including information, such as current traffic status, etc., transmitted from a server (not shown).

As an example, the control unit 4140 selects (or searches for) an optimum path (or the shortest distance/time path into which the TPEG information has been incorporated) among a plurality of paths from a current location to □□ Playground, i.e., a destination, at step S4220.

Thereafter, the control unit 4140 searches for a POI by incorporating preset road information (or road attribute information) into a path included in the result of the search for a path. In this case, the road information includes road types (or usage types) (including, for example, a general road, an overpass, an underground road, a national road, an arterial road, a vehicle-dedicated road, an expressway, etc.), road scales (including, for example, a broad road, a wide road, a middle road, a narrow road, etc.), road functions (including, for example, a main arterial road, a minor arterial road, a collector road, a local load, a special road, etc.), lane information (including, for example, 1 lane, 2 lanes, . . . , N lanes, etc.), facility information (including, for example, a service area, an interchange, an intersection, a junction, a tunnel, a bridge, etc.), road speed information (including, for example, average speed information, lower limit speed information, upper limit speed information, etc.), etc.

That is, the control unit 4140 searches for a POI located around the corresponding path by incorporating the preset road information into the path included in the result of the search for a path.

As an example, when an expressway is included in a path included in the result of the search for a path from the current location to □□ Playground, i.e., the destination, the control unit 4140 searches for one or more service areas (or POIs included in the corresponding service areas) located (or present) on the expressway of the corresponding path in a plurality of POIs located on the corresponding path based on road types (including, for example, an expressway) included in preset road information.

As another example, when a general road is included in a path included in the result of the search for a path from a current location to ∘∘ Building, i.e., a destination, the control unit 4140 searches for one or more POIs, located within a preset radius and corresponding to a 4-lane general road, in a plurality of POIs located on or adjacent to the corresponding path based on road types (including, for example, a general road) and lane information (including, for example, a 4-lane road) included in preset road information at step S4230.

Thereafter, the control unit 4140 outputs the result of the performed search for a path and the retrieved POIs via the display unit 4150 and the voice output unit 4160.

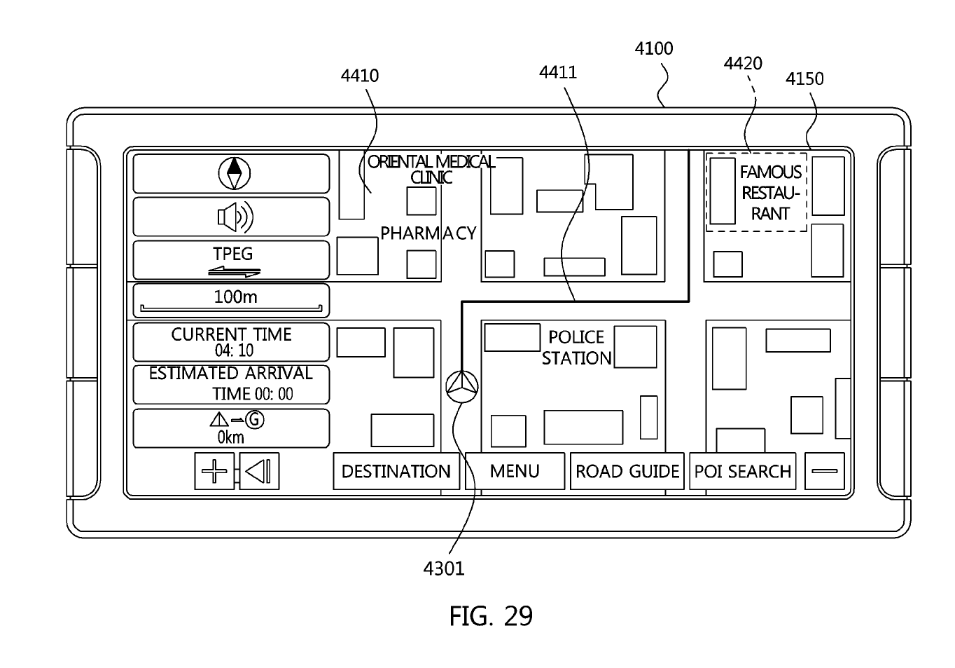

As an example, as shown in FIG. 28, the control unit 4140 indicates a path within the result of the search for a path 4310 made based on destination information (for example, □□ Playground) using a solid line 4311, indicates a point of departure 4312 and a destination 4313, and indicates a service area 4320 location on the expressway of a corresponding path retrieved by applying road types (for example, including an expressway) included in preset road information. In this case, the current location 4301 of the navigation device 4100 may be also displayed.

As another an example, as shown in FIG. 29, the control unit 4140 indicates a path within the result 4410 of the search for a path made based on destination information (for example, ∘∘ Building) using a solid line 4411, and indicates POI information corresponding to restaurant information (or famous restaurant information), within a preset another radius (for example, a few hundred meters), located on the 4-lane general road of a corresponding path, retrieved by applying road types (for example, including a general road) and lane information (for example, including a 4-lane road) included in preset road information, using a dotted line block 4420, thereby additionally providing POI information corresponding to preset road information among paths to the destination.

As described above, when the result of the search for a path is displayed, the control unit 4140 may display POI information corresponding to preset road information as well as a path to a destination.

Furthermore, when the current location of the navigation device 4100 is located adjacent to a corresponding POI corresponding to the preset road information (or the current location of the navigation device 4100 is located within a preset distance from the corresponding POI), the control unit 4140 may output information about the corresponding POI via the display unit 4150 and the voice output unit 4160. That is, the display unit 4150 may flicker information about the corresponding POI under the control of the control unit 4140, or the voice output unit 4160 outputs voice information, for example, “There is a □□ POI within ∘∘ meters,” under the control of the control unit 4140.

Furthermore, when the POI information corresponding to the corresponding road information displayed on the display unit 4150 is selected, the control unit 4140 performs control so that the detailed information of the corresponding POI information is displayed on the display unit 4150.

Furthermore, when the corresponding POI information is selected from the detailed information of the corresponding POI information, displayed on the display unit 4150, as an stop (or when the corresponding POI information displayed on the display unit 4150 is selected), the control unit 4140 may make a search for a path passing through the corresponding POI information, i.e., a stop selected from a path to a final destination, again, and may output the result of the performed search for a path via the display unit 4150 and the voice output unit 4160 at step S4240.

The navigation device and method according to the embodiments of the present invention may be implemented as computer programs, and codes and code segments constituting the computer programs may be easily inferred by a computer programmer in a related filed. Furthermore, the navigation device and method may be implemented in such a manner that the corresponding computer programs may be stored in computer-readable information storage media and read and executed by a computer, the navigation device according to the embodiment of the present invention, or the terminal (or the user device).

The information storage media include magnetic storage media, optical storage media, and carrier wave media. The computer programs that implement the navigation device and method according to the embodiments of the present invention may be stored and installed in the internal memory of the navigation device and the terminal (or the user device). Alternatively, external memory, such as smart cards, in which the computer programs that implement the navigation device and method according to the embodiments of the present invention have been stored and installed may be mounted in the navigation device and the terminal (or the user device) via interfaces.

As described above, in the embodiment of the present invention, a search for a path is made by applying road information (or road attribute information) along the path upon a search for a path, thereby providing a POI search result useful to a user and also improving the convenience of use.

It will be apparent to those having ordinary knowledge in the technical field to which the present invention pertains that various modifications and alterations can be made without departing from the essential characteristics of the present invention. Accordingly, the embodiments disclosed herein are not intended to limit the technical spirit of the present invention, but are intended to illustrate the technical spirit of the present invention. The scope of the technical spirit of the present invention is not limited by these embodiments. The range of protection of the present invention should be defined based on the attached claims, and all technical spirit falling within a range equivalent to the claims should be construed as being included in the range of rights of the present invention.

### INDUSTRIAL APPLICABILITY

According to the present invention, POI objects are collected in a preset POI category, a POI group is generated by grouping some of the POI objects using additional information included in each of the POI objects, related POI objects corresponding to a target POI object corresponding to a request from a user are extracted using the POI group, and information corresponding to the related POI objects is transmitted to the user, so that not only data appropriate for a request from the user but also highly related data can be provided together and, furthermore, application data generated using the related data can be used for effective marketing.

Furthermore, according to the present invention, an AOI is extracted and managed using previously constructed POI data, so that the advantage of enabling the extraction of an accurate AOI without incurring separate costs for the extraction of an AOI can be achieved, thereby contributing to the development of the location-based service industry.

Furthermore, in the present invention, when a user directly modifies a point indicated on an electronic map, a corresponding distance can be changed on an image of a screen by applying the location information of the changed point, and additional information into which the changed location has been incorporated is also displayed. Accordingly, according to the present invention, a user can freely modify a specific one of a plurality of points, displayed on the electronic map for the measurement of a distance, on the screen, so that a scale displayed on a screen can be repeatedly modified even when the user erroneously selects another point when the user measures a distance, and a screen can be intuitively changed, so that the measurement of a distance can be efficiently used. Furthermore, as the location of a specific point is changed on the electronic map, information about a distance and a transportation means is automatically changed and displayed on the image of the electronic map, thereby enabling a user to conveniently use the information. The present invention has industrial applicability because the present invention has a sufficient possibility of commercialization and business and it is apparent that the present invention can be practiced in reality.

Furthermore, according to the present invention, Furthermore, a child POI object can be automatically extracted through a space search for a POI object without manually designating the child POI object, and a 2 or higher-level hierarchical structure can be constructed. Furthermore, task time can be reduced by automatically constructing a hierarchical structure. Moreover, a hierarchical structure can be dynamically maintained, so that maintenance costs are rarely incurred and also immediate application is enabled when a POI or an area is changed. Accordingly, the present invention can contribute to the development of the industry.

Furthermore, according to the present invention, a search for a path can be made by applying road information (or road attribute information) along the path upon a search for a path, so that a POI search result useful to a user is provided and also the convenience of use is improved, thereby being widely used in the navigation field, the terminal field, etc.

1. A device for providing Point Of Interest (POI) information, comprising:
a POI storage unit configured to collect POI objects in a preset POI category;
a POI grouping unit configured to generate a POI group by grouping some of the POI objects using additional information included in each of the POI objects; and
a POI communication unit configured to extract related POI objects corresponding to a target POI object corresponding to a request from a user using the POI group, and to transmit information corresponding to the related POI objects to the user.

2. The device of claim 1, wherein the POI communication unit recommends at least one or more POI objects close to a current location of the user among the related POI objects using basic information of the related POI objects; generates at least one or more of price comparison information and preference ranking information for the related POI objects and provides the generated information to the user; generates a related POI list using at least one or more of the basic information of the related POI objects and the additional information; and generates at least one or more of the price comparison information and the preference ranking information using the related POI list.

3. The device of claim 2, wherein the basic information is information about the POI objects, and the additional information is information about content of the POI objects based on a type of preset POI category.

4. The device of claim 1, wherein the POI grouping unit compares the pieces of additional information included in the POI objects; extracts and groups one or more POI objects having identical or similar additional information among the POI objects; searches for a synonym for the additional information using a thesaurus; and determines POI objects having the synonym as the additional information to be the POI objects having similar additional information.

5. (canceled)

6. A device for extracting an area of interest (AOI) using a POI distribution chart, comprising:
a keyword input unit configured to transfer a keyword input in accordance with a specific area;
a POI distribution chart calculation unit configured to determine location coordinates set for the keyword transferred via the keyword input unit, and to calculate a Point-Of-Interest (POI) distribution chart with the determined location coordinates as its center; and
an area setting unit configured to set an area where a number of POIs is equal to or larger than a predetermined value as an AOI based on the POI distribution chart calculated by the POI distribution chart calculation unit;
wherein the device for extracting an AOI using a POI distribution chart further comprises an interface unit configured to transmit and receive information to and from one or more terminals;
wherein the keyword input unit receives a keyword, input in accordance with a specific area, from any one of the terminals via the interface unit, and determines the keyword;
wherein the POI distribution chart calculation unit determines at least one synonym including a name of an administrative address related to the keyword, determines location coordinates set for the keyword and location coordinates set for the synonym, and calculates a POI distribution chart with the determined location coordinates as its center;
wherein the POI distribution chart calculation unit calculates the POI distribution chart by sequentially moving a scan area from first determined location coordinates to second determined location coordinates, sets a first scan area having a predetermined size at the first location coordinates, determines a number of POIs within the first scan area, and sets a second scan area larger than the first scan area when a number of POIs within the first scan area is equal to or larger than a predetermined value; and
wherein the area setting unit stores information, including at least any one of a name, a category and additional information mapped to at least one POI included in the AOI, with the information being mapped to the AOI.

7. The device of claim 6, wherein the area setting unit;
determines a POI included in the second scan area, connects outer coordinate values of the POI, and sets the connected area as an AOI;
differently sets the first scan area based on a size of the specific area; and
further comprises a service provision unit configured to provide the AOI and information mapped to the AOI in response to a request from a specific terminal.

8. (canceled)

9. (canceled)

10. (canceled)

11. (canceled)

12. (canceled)

13. (canceled)

14. A space search service device, comprising:
an area storage unit configured to store area objects corresponding to areas within a map;
a POI storage unit configured to store a plurality of POI objects, at least some of which match the area objects; and
a search unit configured to, when there is an area object matching a POI object corresponding to an input of a user, make a space search for the POI object and provide an extracted child POI object.

15. The space search service device of claim 14, wherein:
the space search extracts a POI object, present within an area corresponding to an area object matching the POI object that is a target for the space search, as a child POI object;
the search unit makes a space search for the child POI object and then provides an extracted grandchild POI object when there is an area object matching the child POI object;
the space search extracts a POI object matching an overlapping area object as a child POI object when there is the area object whose area overlaps an area object, matching the POI object that is a target for the space search, at a predetermined or higher rate;
the POI object corresponding to the input of the user corresponds to a building, and the child POI object corresponds to a floor of the building; and
areas within the map corresponding to the area objects are polygonal areas.

16. The space search service device of claim 15, wherein the search unit provides a child POI object obtained by excluding a POI object corresponding to a grandchild POI object from the extracted child POI object.

17. (canceled)

18. (canceled)

19. (canceled)

20. (canceled)
